(19) United States
(12) Patent Application Publication
(10) Pub. No.: US 2019/0227971 A1
(43) Pub. Date: Jul. 25, 2019

(54) ARCHITECTURE FOR CONSOLIDATING MULTIPLE SOURCES OF LOW-BANDWIDTH DATA OVER A SERIAL BUS

(71) Applicant: QUALCOMM Incorporated, San Diego, CA (US)

(72) Inventors: Helena Deirdre O'SHEA, San Diego, CA (US); Lalan Jee MISHRA, San Diego, CA (US); Joaquin ROMERA, San Diego, CA (US); Richard Dominic WIETFELDT, San Diego, CA (US); Mohit Kishore PRASAD, San Diego, CA (US)

(21) Appl. No.: 16/193,731

(22) Filed: Nov. 16, 2018

Related U.S. Application Data
(60) Provisional application No. 62/620,987, filed on Jan. 23, 2018.

(51) Int. Cl. G06F 13/40; G06F 13/42

(52) U.S. Cl. CPC G06F 13/4027; G06F 2213/0042; G06F 13/4282

(57) ABSTRACT

Systems, methods, and apparatus are described that provide for communicating coexistence messages over a multi-drop serial bus. A method performed at a first device coupled to a serial bus includes receiving first coexistence information directed to a second device, selecting a communication link to carry the first coexistence information to the second device, generating a first datagram that includes the first coexistence information, transmitting the first datagram to the second device over a point-to-point link in a first mode of operation, and transmitting the first datagram to the second device over a multi-drop serial bus in a second mode of operation. The first datagram may be configured according to a protocol associated with the communication link selected to carry the first coexistence information.

### PRIORITY CLAIM

This application claims priority to and the benefit of U.S. Provisional Patent Application Ser. No. 62/620,987 filed in the U.S. Patent Office on Jan. 23, 2018, the entire content of this application being incorporated herein by reference as if fully set forth below in its entirety and for all applicable purposes.

### TECHNICAL FIELD

The present disclosure relates generally to serial communication and input/output pin configuration and, more particularly, to optimizing an architecture that can consolidate low-latency, low-volume data received from multiple sources onto a multi-drop serial bus.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, which may include a serial bus or a parallel bus. General-purpose serial interfaces known in the industry, including the Inter-Integrated Circuit (I2C or I²C) serial bus and its derivatives and alternatives, such as interfaces defined by the Mobile Industry Processor Interface (MIPI) Alliance, including the I3C interface, the system power management interface (SPMI), and the Radio Frequency Front-End (RFFE) interface.

In one example, the I2C serial bus is a serial single-ended computer bus that was intended for use in connecting low-speed peripherals to a processor. Some interfaces provide multi-master buses in which two or more devices can serve as a bus master for different messages transmitted on the serial bus. In another example, the RFFE interface defines a communication interface for controlling various radio frequency (RF) front-end devices, including power amplifier (PA), low-noise amplifiers (LNAs), antenna tuners, filters, sensors, power management devices, switches, etc. These devices may be collocated in a single integrated circuit (IC) device, or provided in multiple IC devices. In a mobile communications device, multiple antennas and radio transceivers may support multiple concurrent RF links.

In an SOC there can be systems in different chipsets that need to communicate with each other in real-time. One system may provide the other systems awareness of its state using coexistence messages. Coexistence messages are transmitted a multisystem platform to prevent or reduce instances of systems impinging on each other. In many instances, coexistence messages are transmitted over dedicated point-to-point links. These point-to-point links consume precious general-purpose input/output (GPIO) pins within the mobile communication devices and it would be desirable to reduce the number of physical pins needed to carry coexistence information and other low-level signal information or messages.

### SUMMARY

Certain aspects of the disclosure relate to systems, apparatus, methods and techniques that can provide optimized low-latency communications between different devices and to carry coexistence information and messages in datagrams transmitted over multi-drop communication links.

In various aspects of the disclosure, a method performed at a first device coupled to a serial bus includes receiving first coexistence information directed to a second device, selecting a communication link to carry the first coexistence information to the second device, generating a first datagram that includes the first coexistence information, transmitting the first datagram to the second device over a point-to-point link in a first mode of operation, and transmitting the first datagram to the second device over a multi-drop serial bus in a second mode of operation. The first datagram may be configured according to a protocol associated with the communication link selected to carry the first coexistence information. In one example, the first datagram is communicated using a universal asynchronous receiver/transmitter (UART) coupled to the selected communication link in the first mode of operation.

In certain aspects, the method includes receiving second coexistence information directed to a third device coupled to the first device, generating a second coexistence message representative of the second coexistence information, and transmitting a second datagram to the third device over a communication link selected to carry the second coexistence information. The second coexistence information may be configured for communication through a point-to-point data link.

In one aspect, the method includes receiving third coexistence information directed to a first radio frequency component coupled to the multi-drop serial bus, and generating a third coexistence message representative of the third coexistence information. The third coexistence message may be transmitted in accordance with the second mode of operation.

In certain aspects, the method includes generating fourth coexistence information representative of signaling state of a physical general-purpose input/output (GPIO) pin, and generating a fourth coexistence message that includes the fourth coexistence information. The fourth coexistence message may be transmitted in accordance with the second mode of operation. The fourth coexistence message may include virtualized GPIO.

In one aspect, coexistence information is received concurrently from two or more sources and the method includes using a sorting table to determine an order of transmission for coexistence messages including the coexistence information received concurrently from the two or more sources.

In certain aspects, the multi-drop serial bus is one of a plurality of buses coupled to the first device, and the method includes selecting the multi-drop serial bus from among the plurality of buses to carry the first coexistence information based on one or more characteristics of a protocol associated with the multi-drop serial bus. The one or more characteristics of the protocol may include bus latency or bus capacity.

In some aspects, the method includes transmitting a ping message over the multi-drop serial bus, the ping message including status information for a plurality of active sources of the first coexistence information. The method may include transmitting a message over the multi-drop serial bus indicating that one or more sources of the first coexistence information is entering an inactive state.

In various aspects of the disclosure, an apparatus includes a first communication interface configured to couple the apparatus to a multi-drop serial bus operated in accordance with a first protocol, a second communication interface configured to couple the apparatus to a point-to-point link operated in accordance with a second protocol, one or more coexistence message handlers, and a translator.

The coexistence message handler may be configured to receive coexistence information directed to a first device coupled to the multi-drop serial bus and the point-to-point link and generate one or more coexistence messages representative of the coexistence information. The translator may be configured to provide the one or more coexistence messages in first datagrams configured to be transmitted to the first device over the multi-drop serial bus, and provide the one or more coexistence messages in second datagrams configured to be transmitted to the first device over the point-to-point link.

In one aspect, a processor-readable storage medium has instructions stored thereon. The instructions, when executed by at least one processor or state machine of a processing circuit, cause the processing circuit to receive first coexistence information directed to a first device coupled to the processing circuit, select a communication link to carry the first coexistence information to the first device, generate a first datagram that includes the first coexistence information, transmit the first datagram to the first device over a point-to-point link in a first mode of operation, and transmit the first datagram to the first device over a multi-drop serial bus in a second mode of operation. The first datagram may be configured according to a protocol associated with the communication link selected to carry the first coexistence information.

In various aspects of the disclosure, an apparatus includes means for receiving first coexistence information directed to a first device coupled to a multi-drop serial bus, means for selecting a first communication link to carry the first coexistence information to the first device, means for generating a first datagram that includes the first coexistence information, and means for transmitting the first datagram to the first device over the first communication link. The first datagram may be configured according to a protocol associated with the first communication link. The first datagram may be transmitted over a point-to-point link to the first device in a first mode of operation. The first datagram may be transmitted over a multi-drop serial bus to the first device in a second mode of operation.

### BRIEF DESCRIPTION OF THE DRAWINGS

FIG. 1 illustrates certain aspects of a system adapted to support coexistence management functions.

FIG. 2 illustrates an example of a conventional coexistence management interface (CxMi) implementation.

FIG. 3 illustrates a system architecture for an apparatus employing a data link between IC devices.

FIG. 4 illustrates a first example of a device configuration for coupling various radio frequency front-end devices using multiple RFFE buses.

FIG. 5 illustrates a second example of a device configuration for coupling various radio frequency front-end devices using multiple RFFE buses.

FIG. 6 illustrates a device that employs an SPMI bus to couple various front-end devices in accordance with certain aspects disclosed herein.

FIG. 7 illustrates a communication interface in which a plurality of devices is connected using a serial bus operated in accordance with an I2C or I3C protocol.

FIG. 8 includes a timing diagram that illustrates signaling on a serial bus when the serial bus is operated in a single data rate (SDR) mode of operation defined by I3C specifications.

FIG. 9 illustrates an apparatus that includes an Application Processor and multiple peripheral devices that may be adapted according to certain aspects disclosed herein.

FIG. 10 illustrates a device that employs a serial bus to couple various front-end devices in accordance with certain aspects disclosed herein.

FIG. 11 illustrates an apparatus that has been adapted to support Virtual GPIO in accordance with certain aspects disclosed herein.

FIG. 12 illustrates an example of a system which includes one or more communication links configured to exchange coexistence management messages.

FIG. 13 illustrates an example of a system which virtualizes and consolidates communication of GPIO state associated with multiple devices and/or communication links using a single serial communication link in accordance with certain aspects disclosed herein.

FIG. 14 illustrates an example of a co-existence management architecture that may be adapted in accordance with certain aspects disclosed herein.

FIG. 15 illustrates a first example of a coexistence management architecture that may be implemented using a multi-drop serial bus in accordance with certain aspects disclosed herein.

FIG. 16 illustrates a second example of a coexistence management architecture that may be implemented using a multi-drop serial bus in accordance with certain aspects disclosed herein.

FIG. 17 illustrates a third example of a coexistence management architecture that may be implemented using a multi-drop serial bus in accordance with certain aspects disclosed herein.

FIG. 18 illustrates a fourth example of a coexistence management architecture that may be implemented using a multi-drop serial bus in accordance with certain aspects disclosed herein.

FIG. 19 illustrates certain operational aspects of a coexistence management architecture provided in accordance with certain aspects disclosed herein.

FIG. 20 illustrates an example of a memory configuration that may be employed in certain coexistence management architectures provided in accordance with certain aspects disclosed herein.

FIG. 21 illustrates an example of sort/priority processing in accordance with certain aspects disclosed herein.

FIG. 22 illustrates an example of concurrent messaging when multiple active sources of coexistence problems are present in accordance with certain aspects disclosed herein.

FIG. 23 illustrates one example of an apparatus employing a processing circuit that may be adapted according to certain aspects disclosed herein.

FIG. 24 is a flowchart illustrating certain operations of device adapted in accordance with certain aspects disclosed herein.

FIG. 25 illustrates an example of a hardware implementation for an apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple system-on-chip (SoC) or other IC devices often employ a shared communication interface that may include a serial bus or another data communication link to connect processors with modems and other peripherals. The serial bus or other data communication link may be operated in accordance with multiple standards or protocols defined. In one example, a serial bus may be operated in accordance with I2C, I3C, SPMI and/or RFFE protocols.

In some conventional systems, coexistence messages are sent over point-to-point data links that support low-volume, low-latency transport of byte-sized messages. According to certain aspects disclosed herein, number of physical GPIO pins consumed by the point-to-point data links can be eliminated by transferring coexistence information over shared serial buses. In various aspects of the disclosure, a method performed at a device coupled to a serial bus includes receiving first coexistence information directed to a first device coupled to the serial bus, generating a first coexistence message representative of the first coexistence information, converting the first coexistence message to obtain a first datagram that includes the first coexistence information, and transmitting the first datagram to the first device over the serial bus. The first coexistence message may be configured for communication through a point-to-point data link. The first datagram may be configured according to a first protocol associated with the serial bus.

A number of different transmission schemes may be used for communicating messaging and data over communication links. Existing protocols have well-defined and immutable structures in the sense that their structures cannot be changed. In some examples, a serial communication bus that is operated in accordance with I2C, I3C, RFFE, SPMI, or other standards or protocols may be used to tunnel different protocols with different register and data format requirements, different data transmission volumes and/or different transmission schedules.

According to certain aspects of this disclosure, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

### Examples of CxMi Communication

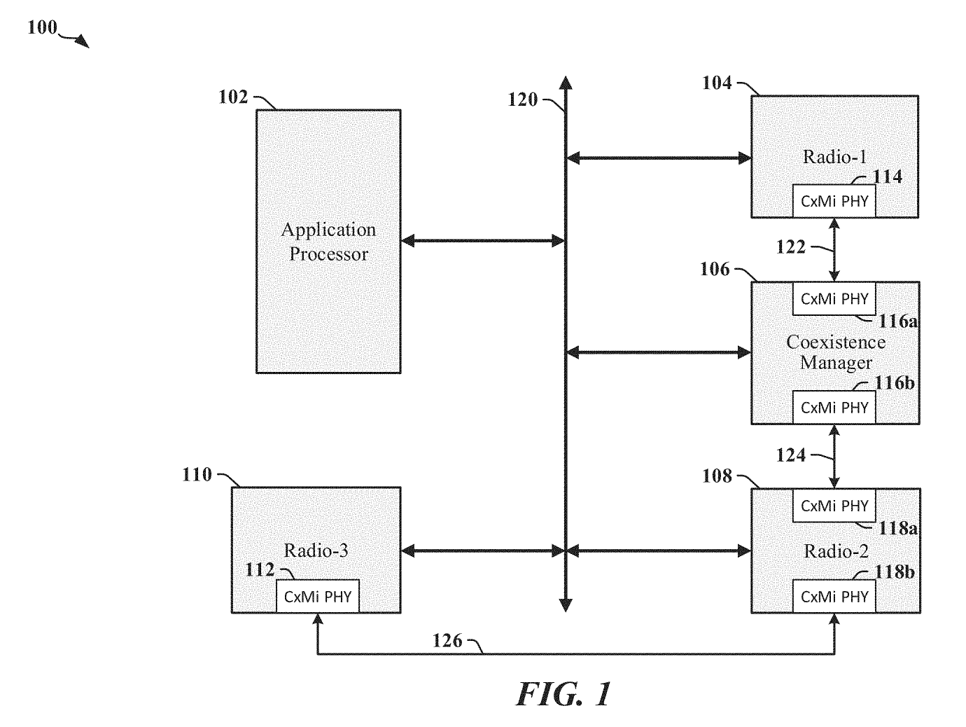

FIG. 1 illustrates certain aspects of a system 100 adapted to support coexistence management functions. An application processor 102 may manage or control multiple radios 104, 108, 110, each of which may include one or more modems, transceivers, antennas, etc. In some instances, the multiple radios 104, 108, 110 may share certain circuits, antennas and other resources. The system 100 may provide or employ a coexistence manager 106 that may be a standalone device and/or employ functions and circuits in one or more devices 102, 104, 106, 108, 110. In one example, the coexistence manager 106 may communicate with radios 104, 108 through point-to-point CxMi links 122, 124, respectively. In another example, coexistence management functions in two radios 108, 110 may interact through a point-to-point CxMi link 126. CxMi physical interface circuits 112, 114, 116a, 116b, 118a, 118b provided in the radios 104, 108, 110 and/or coexistence manager 106 may be based on a UART. Each CxMi link 122, 124, 126 consumes at least two pins on each device for full-duplex operation.

An example mobile device may include various radios to provide a variety of functions for the user. For purposes of this example, a cellular telephone may include a third generation (3G), fourth generation (4G) and/or fifth generation (5G) radio for voice and data, an IEEE 802.11 (WiFi) radio, a Global Positioning System (GPS) radio, and/or a Bluetooth radio, where two or more radios may operate simultaneously.

The coexistence manager 106 and/or coexistence functions and circuits can manage operation of respective radios 104, 108, 110 in order to avoid interference and/or other performance degradation associated with collisions between respective radios 104, 108, 110. Coexistence management functions typically require deterministic communication of commands, configuration and other information. A point-to-point UART-based link can provide sufficiently low latency to support coexistence management functions. Conventional shared communication links and communication protocols may be unable to meet the latency requirements needed to support coexistence management functions. Certain aspects disclosed herein provide systems, apparatus and techniques by which CxMi communication links can be virtualized such that CxMi information can be timely transported as virtual general-purpose input/output (VGPIO or VGI) over a serial bus configured to operate as a multi-point VGI (MP-VGI) bus.

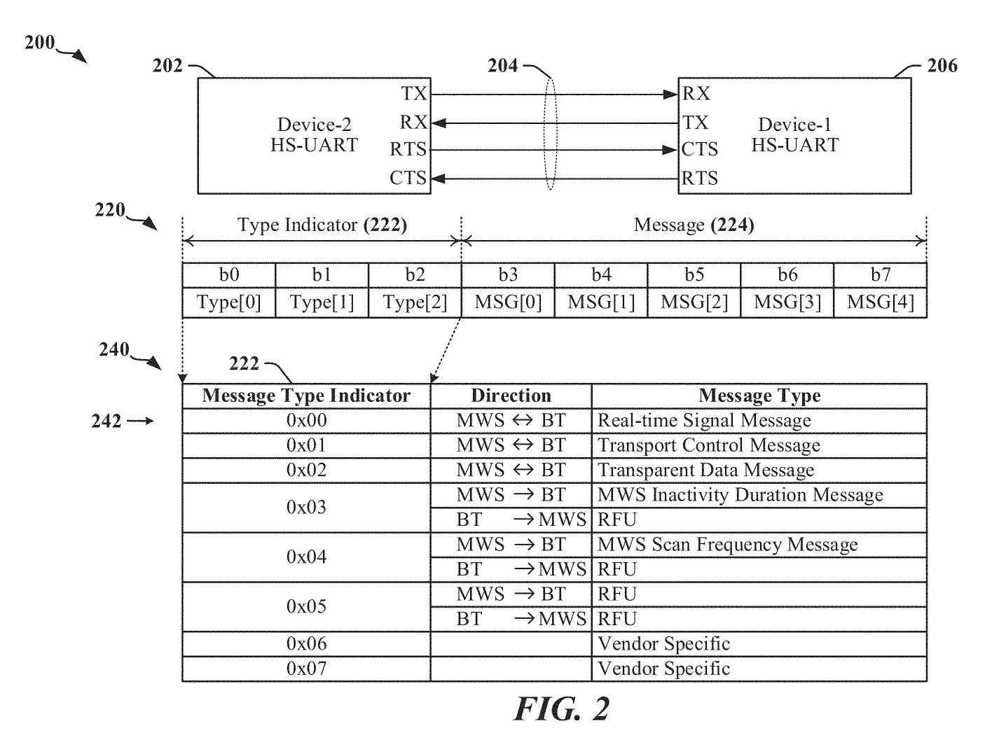

FIG. 2 illustrates an example of a conventional CxMi implementation 200 that includes a point-to-point UART-based link that may be operated at 4 Mbps. In the example, a first modem 202 is configured for operation using a mobile wireless service (MWS) radio access technology and a second modem 206 is configured for Bluetooth (BT) communications. The modems 202, 206 exchange CxMi messages, commands and/or control information over a two-wire UART-based point-to-point CxMi link 204. In one example, data is clocked on the CxMi link 204 at 4 megabits per second (Mbps), and each 8-bit byte of data transferred through the CxMi link 204 is preceded by a start bit and followed by a stop bit such that transmission is accomplished in 10 clock cycles, or 2.5 μs.

FIG. 2 includes an example of a datagram 220 for a wireless coexistence interface (WCI). In some implementations, the datagram 220 may comply or be compatible with a datagram provided in accordance with the WCI-2 protocol defined for communication using a UART-based interface. The datagram includes a type indicator field 222 and a message field 224. The type indicator field 222 includes three bits encoded to identify the content of the message field 224. Eight possible message types are defined in the table 240 in FIG. 2. The Type-0 message 242 has a value of 0x00 and carry VGI-like event messages with strict latency targets. When the CxMi link 204 is operated at 4-Mbps, transmissions including a Type-0 message 242 include 1 Start bit, 8 data-bits and one Stop-bit for a total of 10 bits. Transmission time is 2.5 μs and Type-0 messages 242 are subjected to hard real-time, deterministic constraints, where transmissions are expected to be completed in less than 3 μs, for example.

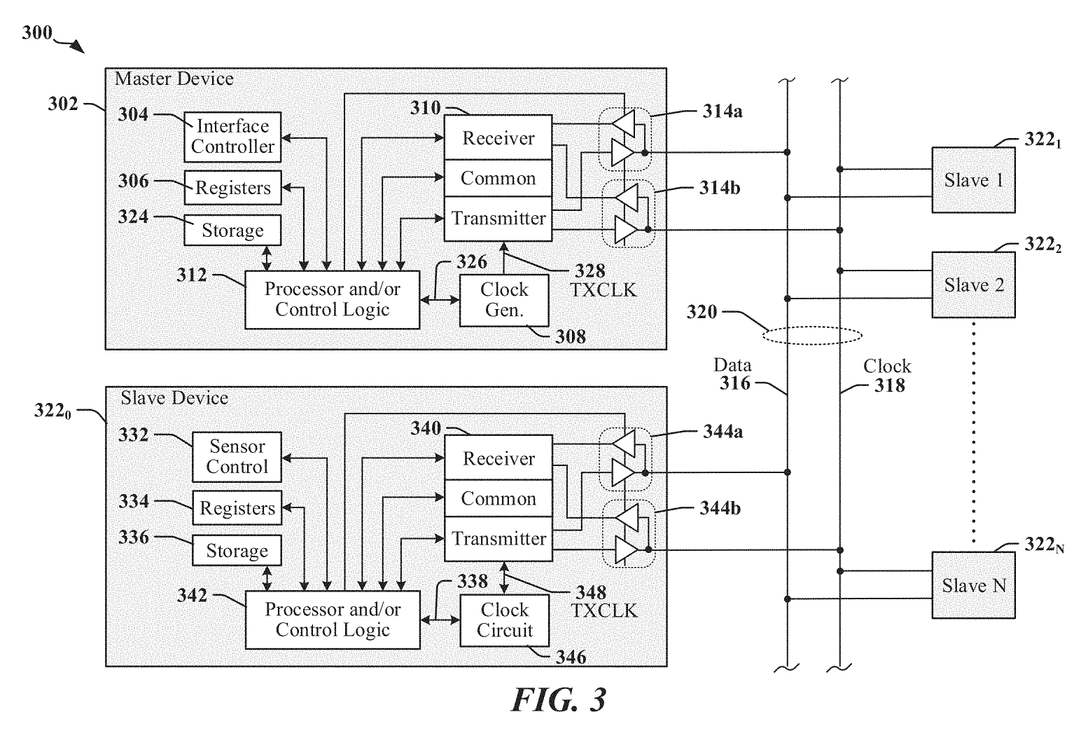

FIG. 3 illustrates certain aspects of an apparatus 300 that includes multiple devices 302, and 322₀-322_{N} coupled to a serial bus 320. The devices 302 and 322₀-322_{N} may be implemented in one or more semiconductor IC devices, such as an applications processor, SoC or ASIC. In various implementations the devices 302 and 322₀-322_{N} may include, support or operate as a modem, a signal processing device, a display driver, a camera, a user interface, a sensor, a sensor controller, a media player, a transceiver, and/or other such components or devices. In some examples, one or more of the slave devices 322₀-322_{N} may be used to control, manage or monitor a sensor device. Communications between devices 302 and 322₀-322_{N} over the serial bus 320 is controlled by a bus master 302. Certain types of bus can support multiple bus master devices 302.

In one example, a bus master device 302 may include an interface controller 304 that may manage access to the serial bus, configure dynamic addresses for slave devices 322₀-322_{N} and/or generate a clock signal 328 to be transmitted on a clock line 318 of the serial bus 320. The bus master device 302 may include configuration registers 306 or other storage 324, and other control logic 312 configured to handle protocols and/or higher-level functions. The control logic 312 may include a processing circuit such as a state machine, sequencer, signal processor or general-purpose processor. The bus master device 302 includes a transceiver 310 and line drivers/receivers 314a and 314b. The transceiver 310 may include receiver, transmitter and common circuits, where the common circuits may include timing, logic and storage circuits and/or devices. In one example, the transmitter encodes and transmits data based on timing in the clock signal 328 provided by a clock generation circuit 308. Other timing clocks 326 may be used by the control logic 312 and other functions, circuits or modules.

At least one device 322₀-322_{N} may be configured to operate as a slave device on the serial bus 320 and may include circuits and modules that support a display, an image sensor, and/or circuits and modules that control and communicate with one or more sensors that measure environmental conditions. In one example, a slave device 322₀ configured to operate as a slave device may provide a control function, module or circuit 332 that includes circuits and modules to support a display, an image sensor, and/or circuits and modules that control and communicate with one or more sensors that measure environmental conditions. The slave device 322₀ may include configuration registers 334 or other storage 336, control logic 342, a transceiver 340 and line drivers/receivers 344a and 344b. The control logic 342 may include a processing circuit such as a state machine, sequencer, signal processor or general-purpose processor. The transceiver 310 may include receiver, transmitter and common circuits, where the common circuits may include timing, logic and storage circuits and/or devices. In one example, the transmitter encodes and transmits data based on timing in a clock signal 348 provided by clock generation and/or recovery circuits 346. The clock signal 348 may be derived from a signal received from the clock line 318. Other timing clocks 338 may be used by the control logic 342 and other functions, circuits or modules.

The serial bus 320 may be operated in accordance with RFFE, I2C, I3C, SPMI, or other protocols. At least one device 302, 322₀-322_{N} may be configured to operate as a master device and a slave device on the serial bus 320. Two or more devices 302, 322₀-322_{N} may be configured to operate as a master device on the serial bus 320.

In some implementations, the serial bus 320 may be operated in accordance with an I3C protocol. Devices that communicate using the I3C protocol can coexist on the same serial bus 320 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 320, in addition to data formats and aspects of bus control. In some aspects, the I2C and I3C protocols may define direct current (DC) characteristics affecting certain signal levels associated with the serial bus 320, and/or alternating current (AC) characteristics affecting certain timing aspects of signals transmitted on the serial bus 320. In some examples, a 2-wire serial bus 320 transmits data on a data line 316 and a clock signal on the clock line 318. In some instances, data may be encoded in the signaling state, or transitions in signaling state of the data line 316 and the clock line 318.

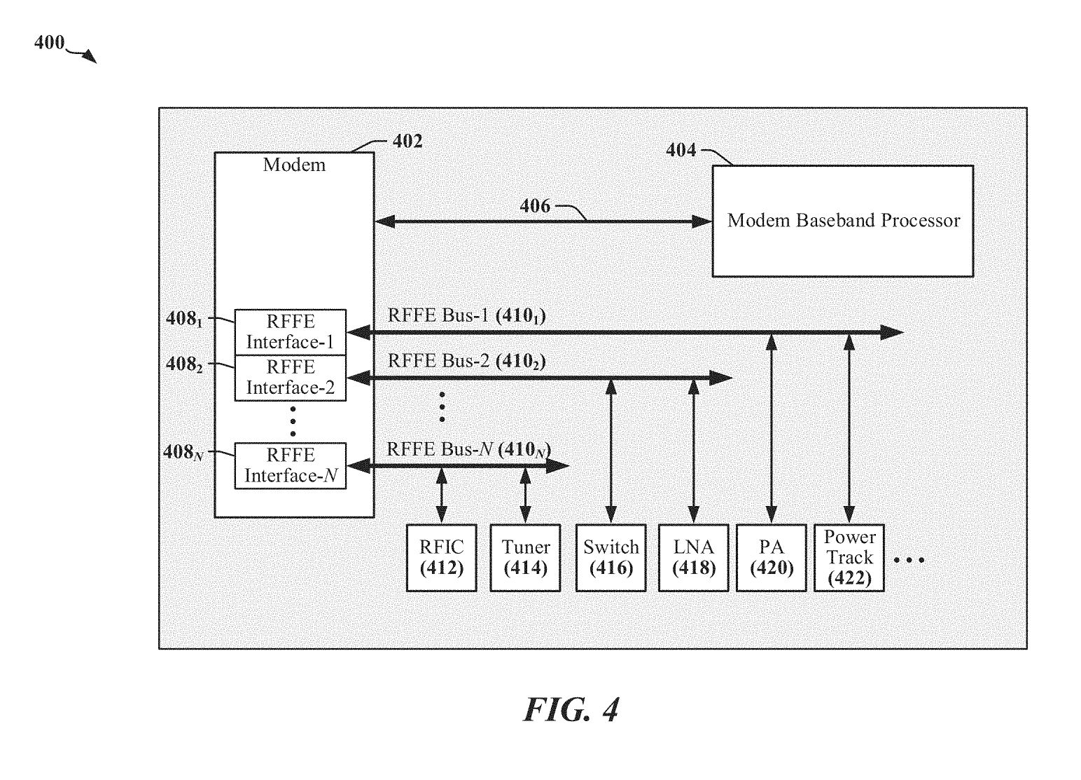

FIG. 4 is a block diagram illustrating a first example of an apparatus 400 that includes chipsets or devices coupled by multiple communication links. In the example, the apparatus 400 employs multiple RFFE buses 410₁-410_{N} to couple various front-end devices 412, 414, 416, 418, 420, 422. A modem 402 may include one or more RFFE interfaces 408₁-408_{N}, each of which couples the modem 402 to a corresponding RFFE bus 410₁-410_{N}. The modem 402 communicates with a baseband processor 404 through a separate communication link 406. The illustrated apparatus 400 may be embodied in one or more of a mobile communication device, a mobile telephone, a mobile computing system, a mobile telephone, a notebook computer, a tablet computing device, a media player, a gaming device, a wearable computing and/or communications device, an appliance, or the like. In various examples, the apparatus 400 may include one or more baseband processors 404, modems 402, multiple communications links, multiple RFFE buses 410₁-410_{N} and/or other types of buses. The apparatus 400 may include other processors, circuits, modules and may be configured for various operations and/or different functionalities. In the apparatus 400 illustrated in FIG. 4, one RFFE bus 410_{N} is coupled to an RF integrated circuit (RFIC 412) and an RF tuner 414. The RFIC 412 may include one or more controllers, state machines and/or processors that configure and control certain aspects of the RF front-end. Another RFFE bus 410₂ may couple the modem 402 to a switch 416 and a low noise amplifier (LNA 418). Another RFFE bus 410₁ may couple the modem 402 to a power amplifier (PA 420) and a power tracking module 422. Other types of devices may be coupled by one or more of the RFFE buses 410₁-410_{N}, and other assignments and allocations of devices 412, 414, 416, 418, 420, 422 to RFFE buses 410₁-410_{N} may be configured according to application needs.

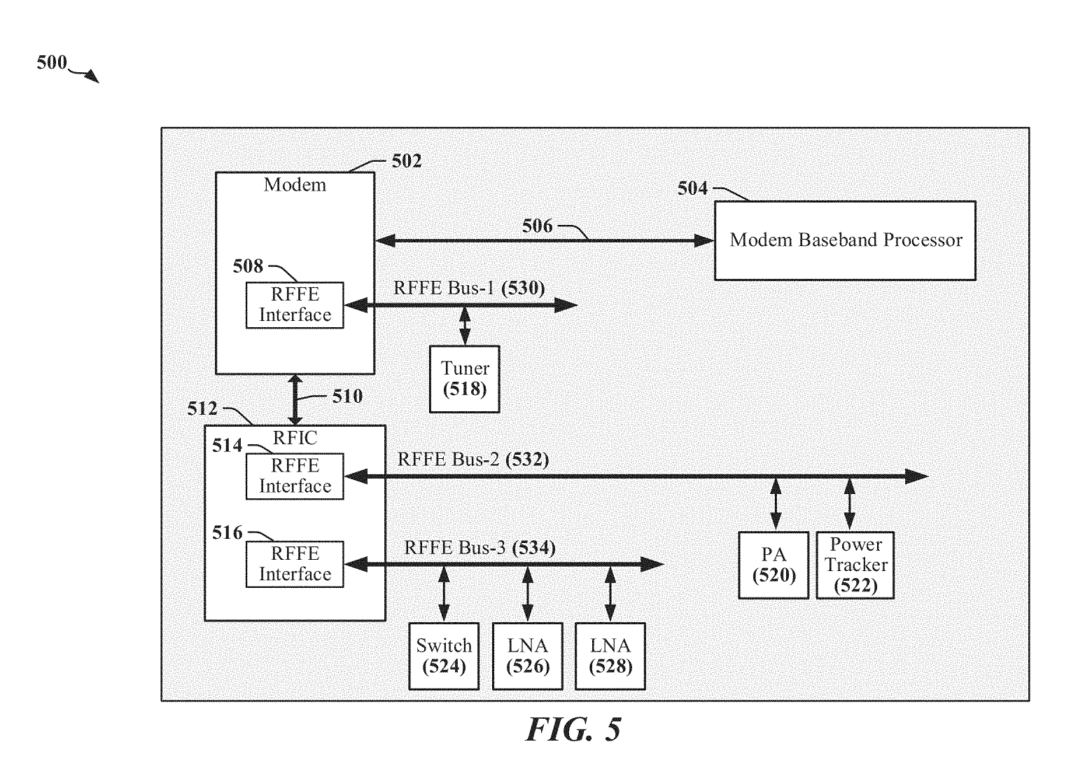

FIG. 5 is a block diagram illustrating a second example of an apparatus 500 that includes chipsets or devices, in which various RF front-end devices 518, 520, 522, 524, 526 528 are coupled by multiple RFFE buses 530, 532, 534. In this example, a modem 502 includes an RFFE interface 508 that couples the modem 502 to a first RFFE bus 530. The modem 502 may communicate with a baseband processor 504 and an RFIC 512 through one or more communication links 506, 510. The illustrated apparatus 500 may be embodied in one or more of a mobile communication device, a mobile telephone, a mobile computing system, a mobile telephone, a notebook computer, a tablet computing device, a media player, a gaming device, a wearable computing and/or communications device, an appliance, or the like.

In various examples, the apparatus 500 may be implemented with one or more baseband processors 504, modems 502, RFICs 512, multiple communications links 506, 510, multiple RFFE buses 530, 532, 534 and/or other types of buses. The apparatus 500 may include other processors, circuits, modules and may be configured for various operations and/or different functionalities. In the apparatus 500 illustrated in FIG. 5, the Modem 502 is coupled to an RF tuner 518 through its RFFE interface 508 and the first RFFE bus 530. The RFIC 512 may include one or more RFFE interfaces 514, 516, controllers, state machines and/or processors that configure and control certain aspects of the RF front-end. The RFIC 512 may communicate with a PA 520 and a power tracking module 522 through a first RFFE interface 514 and the second RFFE bus 532. The RFIC 512 may communicate with a switch 524 and one or more LNAs 526, 528 through a second RFFE interface 516 and the third RFFE bus 534.

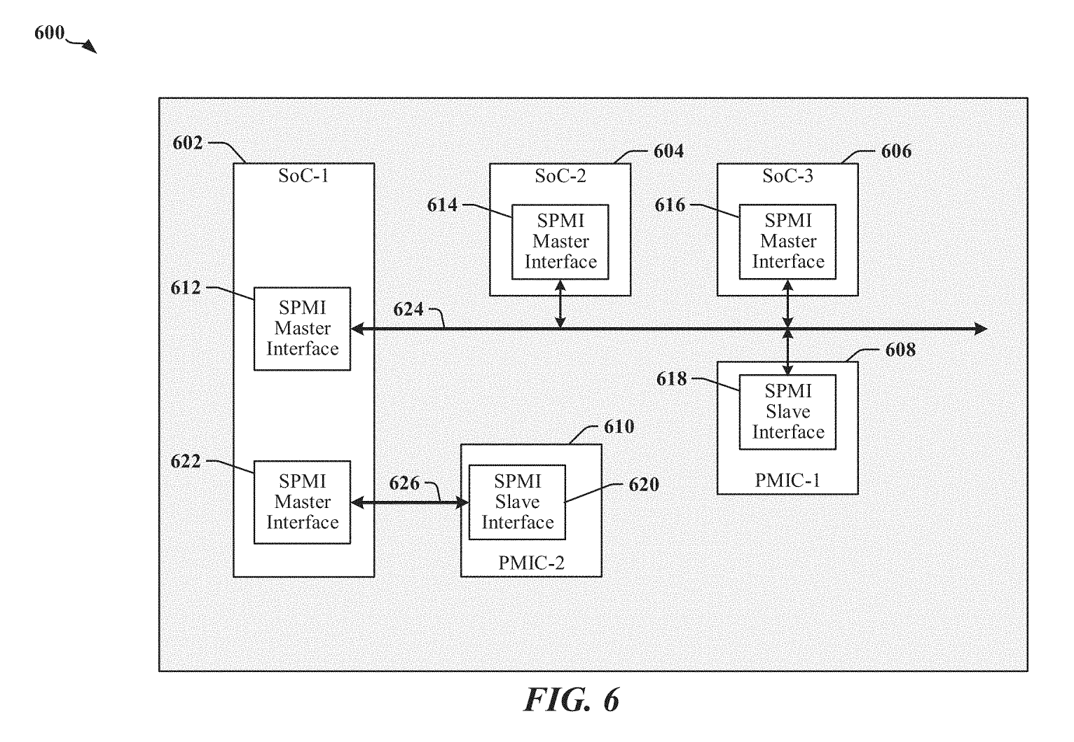

FIG. 6 illustrates an example of a system 600 that employs one or more serial buses 624, 626 operated in accordance with SPMI protocols. In various examples, SPMI protocols may be used to provide a power management control bus that can communicate commands to cause circuits and/or functional components to reset, sleep, shutdown, wakeup, and so on. In some implementations, SPMI protocols may be used to implement a general-purpose communication link. A two-wire serial bus 624, 626 may connect one or more master devices 602, 604, 606 to multiple slave devices (PMICs 608, 610). In one implementation, between one and four master devices may be coupled to the serial bus 624, 626 and up to 16 slave devices may be supported. The serial bus 624, 626 includes a first wire (SCLK) that carries a clock signal and a second wire that carries a data signal (SDATA). SPMI protocols support bus contention arbitration, request arbitration and group addressing to permit the PMICs 608, 610 to be written concurrently or simultaneously by a master device (SoCs 602, 604, 606). In some implementations, SPMI supports a low-speed mode that operates with a clock frequency of between 32 kHz and 15 MHz, and a high-speed mode that operates with a clock frequency of between 32 kHz and 26 MHz. SPMI devices may be required to acknowledge certain commands.

In the illustrated example, the system 600 includes three SoCs 602, 604, 606 and two power management integrated circuits (PMICs 608, 610). Other types of peripheral devices may be coupled to a serial bus 624, 626 operated in accordance with SPMI protocols. In the illustrated system 600, a first serial bus 624 couples a bus master 612, 614, 616 on each SoC 602, 604, 606 and a bus slave 618 on a first PMIC 608, with a second serial bus 626 couples a bus slave 620 in a second PMIC 610 to an additional bus master 622 provided in one SoC 602.

### Data Transfers Over an I3C Serial Bus

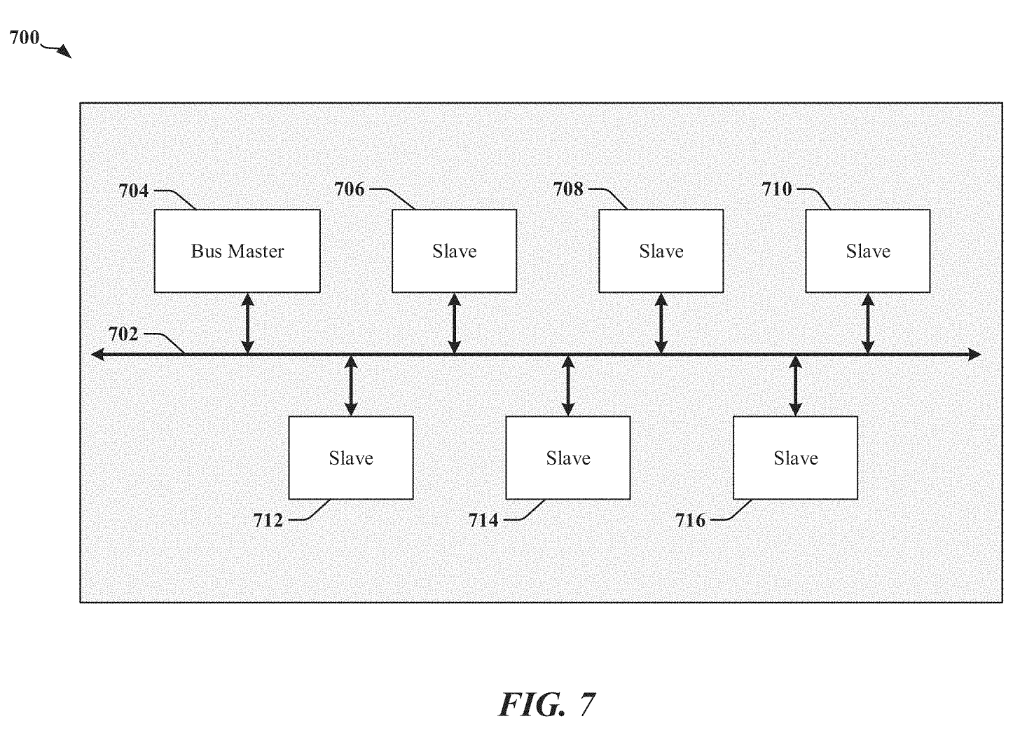

FIG. 7 illustrates a system 700 in which multiple devices 704, 706, 708, 710, 712, 714 and 716 are connected using a serial bus 702 that may be operated in accordance with I2C and/or I3c protocols. In one example, the devices 704, 706, 708, 710, 712, 714 and 716 may be adapted or configured to communicate over the serial bus 702 in accordance with an I3C protocol. In some instances, one or more of the devices 704, 706, 708, 710, 712, 714 and 716 may alternatively or additionally communicate using other protocols, including an I2C protocol, for example.

Communication over the serial bus 702 may be controlled by a master device 704. In one mode of operation, the master device 704 may be configured to provide a clock signal that controls timing of transmission of data encoded in a data signal. In another mode of operation, two or more of the devices 704, 706, 708, 710, 712, 714 and 716 may be configured to exchange data encoded in symbols, where timing information is embedded in the signaling state of both wires in each symbol transmission interval.

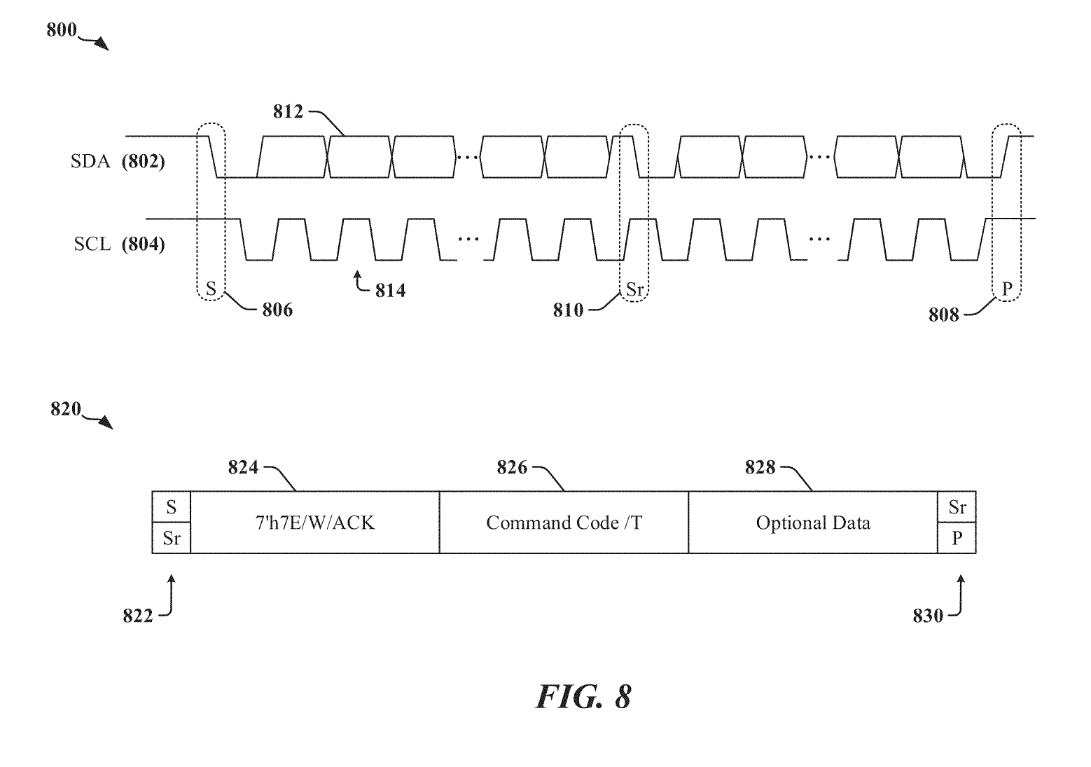

FIG. 8 includes a timing diagram 800 that illustrates signaling on a serial bus when the serial bus is operated in a single data rate (SDR) mode of operation defined by I3C specifications. Data transmitted on a first wire (SDATA 802) of the serial bus may be captured using a clock signal transmitted on a second wire (SCLK 804) of the serial bus. During data transmission, the signaling state 812 of SDATA 802 is expected to remain constant for the duration of the pulses 814 when SCLK 804 is at a high voltage level. Transitions on SDATA 802 when SCLK 804 is at the high voltage level indicate a START condition 806, a STOP condition 808 or a repeated START 810.

On an I3C serial bus, a START condition 806 is defined to permit the current bus master to signal that data is to be transmitted. The START condition 806 occurs when SDATA 802 transitions from high to low while SCLK 804 is high. The bus master may signal completion and/or termination of a transmission using a STOP condition 808. The STOP condition 808 is indicated when SDATA 802 transitions from low to high while SCLK 804 is high. A repeated START 810 may be transmitted by a bus master that wishes to initiate a second transmission upon completion of a first transmission. The repeated START 810 is transmitted instead of a STOP condition 808 and has the significance of the STOP condition 808 followed immediately by a START condition 806. The repeated START 810 occurs when SDATA 802 transitions from high to low while SCLK 804 is high.

The bus master may transmit an initiator 822 that may be a START condition 806 or a repeated START 810 prior to transmitting an address of a slave, a command, and/or data. FIG. 8 illustrates a command code transmission 820 by the bus master. The initiator 822 may be followed in transmission by a predefined command 824 indicating that a command code 826 is to follow. The command code 826 may, for example, cause the serial bus to transition to a desired mode of operation. In some instances, data 828 may be transmitted. The command code transmission 820 may be followed by a terminator 830 that may be a STOP condition 808 or a repeated START 810.

Certain serial bus interfaces support signaling schemes that provide higher data rates. In one example, I3C specifications define multiple high data rate (HDR) modes, including a high data rate, double data rate (HDR-DDR) mode in which data is transferred at both the rising edge and the falling edge of the clock signal.

### Virtual General-Purpose Input/Output

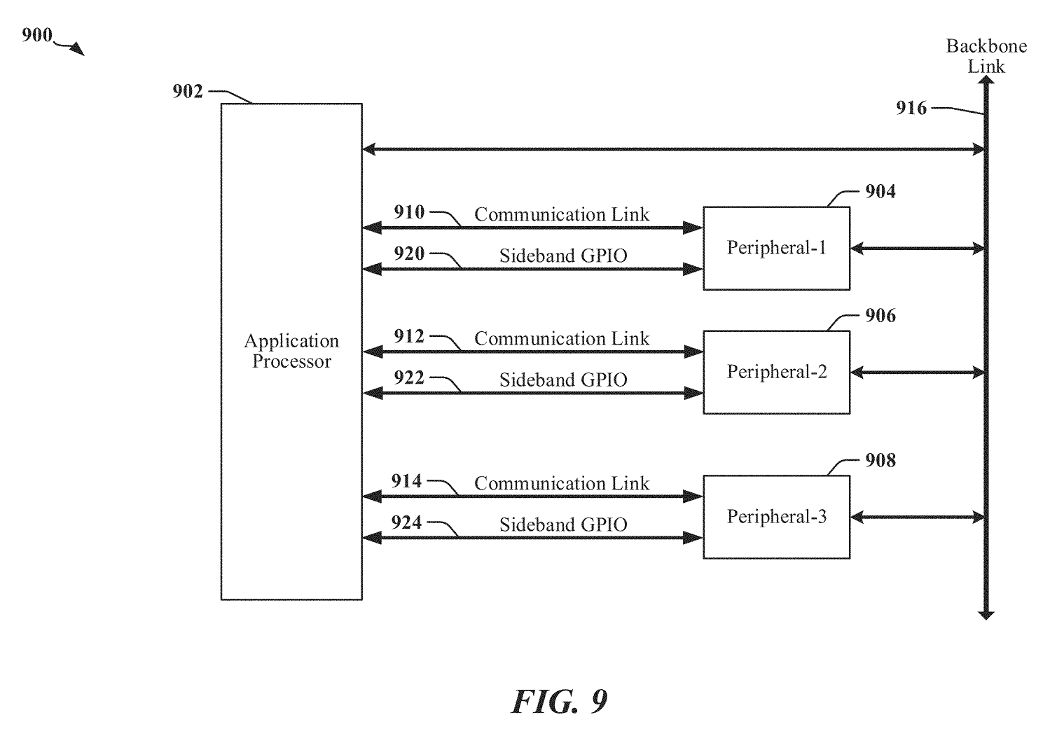

Mobile communication devices, and other devices that are related or connected to mobile communication devices, increasingly provide greater capabilities, performance and functionalities. In many instances, a mobile communication device incorporates multiple IC devices that are connected using a variety of communications links. FIG. 9 illustrates an apparatus 900 that includes an Application Processor 902 and multiple peripheral devices 904, 906, 908. In the example, each peripheral device 904, 906, 908 communicates with the Application Processor 902 over a backbone link 916 and a respective communication link 910, 912, 914, which may be operated in accordance with one or more protocols, that may be different from one another. Communication between the Application Processor 902 and each peripheral device 904, 906, 908 may involve additional wires that carry control or command signals between the Application Processor 902 and the peripheral devices 904, 906, 908. These additional wires may be referred to as sideband general purpose input/output (sideband GPIO 920, 922, 924), and in some instances the number of connections needed for sideband GPIO 920, 922, 924 can exceed the number of connections used for a communication link 910, 912, 914.

GPIO provides generic pins/connections that may be customized for particular applications. For example, a GPIO pin may be programmable to function as an output, input pin or a bidirectional pin, in accordance with application needs. In one example, the Application Processor 902 may assign and/or configure a number of GPIO pins to conduct handshake signaling or inter-processor communication (IPC) with a peripheral device 904, 906, 908 such as a modem. When handshake signaling is used, sideband signaling may be symmetric, where signaling is transmitted and received by the Application Processor 902 and/or one or more of the peripheral devices 904, 906, 908. With increased device complexity, an associated increase in the number of GPIO pins used for IPC communication may significantly escalate manufacturing costs and limit GPIO availability for other system-level peripheral interfaces.

According to certain aspects of this disclosure, the state of GPIO, including GPIO associated with a communication link, may be captured, serialized and transmitted over a data communication link. In one example, captured GPIO may be transmitted in packets over a serial bus operated in accordance with an I2C, I3C, RFFE, SPMI and/or another protocol. In the example of a serial bus operated in accordance with I3C protocols, common command codes may be used to indicate packet payload and/or destination. The communication links 910, 912, 914 may be used to inform the peripherals of changes to priority of different messages. The backbone link 916 may be used to provide high level coordination messaging and general control messaging between the peripheral devices 904, 906, 908 and the Application Processor 902.

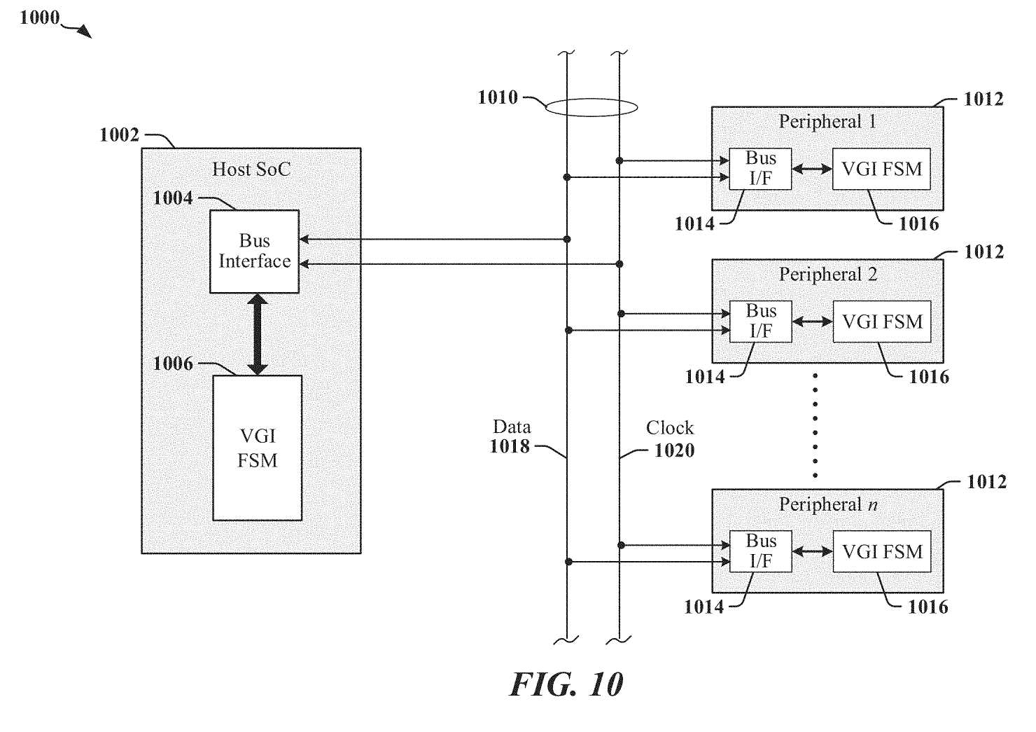

FIG. 10 illustrates an example of an apparatus 1000 that uses a multi-drop serial bus 1010 to couple various devices including a host SoC 1002 and one or more peripheral devices 1012. The host SoC 1002 may include a virtual GPIO finite state machine (VGI FSM 1006) and a bus interface 1004, where the bus interface 1004 cooperates with corresponding bus interfaces 1014 in the peripheral devices 1012 to operate on a communication link deployed between the host SoC 1002 and the peripheral devices 1012. In the example, each peripheral device 1012 includes a VGI FSM 1016 that can manage translations between GPIO state and messages carrying virtualized GPIO. In the illustrated example, virtualized GPIO messages may be serialized and exchanged by the SoC 1002 and one or more peripheral devices 1012 over the multi-drop serial bus 1010 in accordance with an I3C protocol or another protocol. The host SoC 1002 may include one or more bus interfaces, including interfaces that support I2C, I3C, SPMI and/or RFFE protocols. In some examples, the host SoC 1002 may include a configurable interface that may be employed to communicate using I2C, I3C, SPMI, RFFE and/or another suitable protocol. In some examples, the multi-drop serial bus 1010 may transmit data in a signal carried on a data wire 1018 and timing information in a clock signal carried on a clock wire 1020.

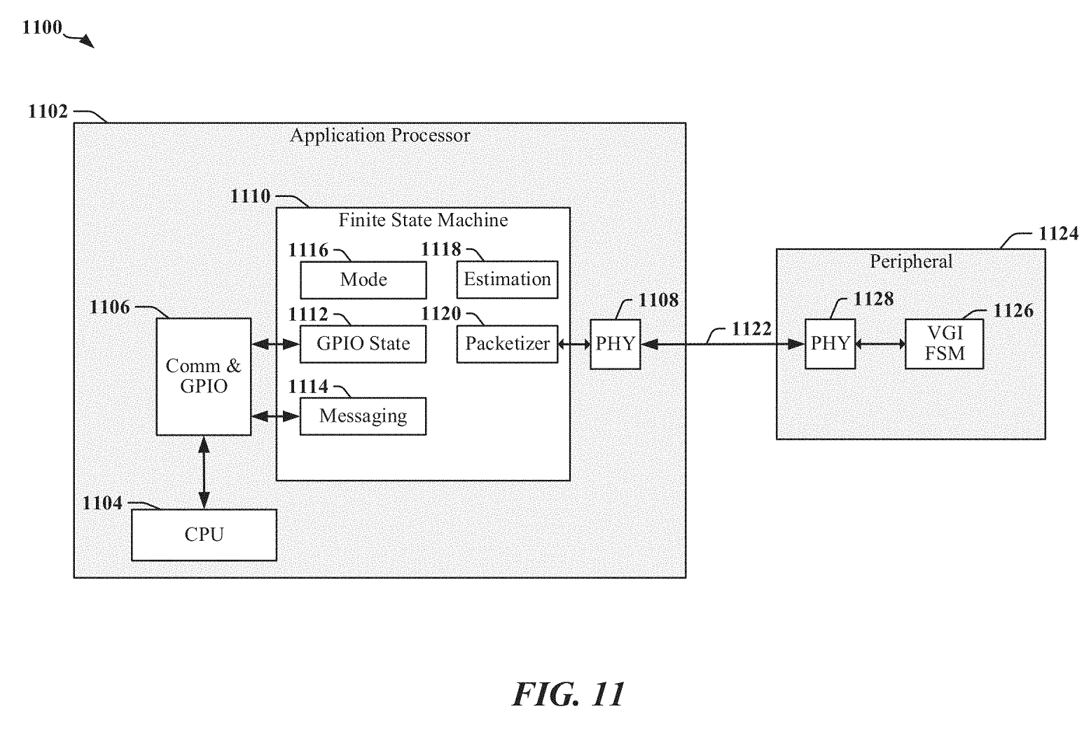

FIG. 11 illustrates an apparatus 1100 that is adapted to support Virtual GPIO (VGI or VGMI) in accordance with certain aspects disclosed herein. VGI-capable circuits and techniques can reduce the number of physical pins and connections used to connect an Application Processor 1102 with a peripheral device 1124. VGI enables GPIO state from a plurality sources to be serialized into VGI messages that can be transmitted over a communication link 1122. In one example, VGI messages may be encoded in packets that are transmitted over a communication link 1122 that includes a multi-drop serial bus. A receiving peripheral device 1124 may deserialize received packets and may extract VGI messages and other types of message from a received transmission. In one example, a VGI FSM 1126 in the peripheral device 1124 may convert the VGI messages to physical GPIO signals that can be presented at an internal GPIO interface.

In another example, the communication link 1122 may be accessed through a radio frequency transceiver that supports RF communication using, for example, a Bluetooth protocol, a WLAN protocol, a cellular wide area network protocol, and/or another RF communication protocol. When the communication link 1122 includes an RF connection, VGI messages may be encoded with other types of messages in packets, frames, subframes, or other structures that can be transmitted over the communication link 1122. The receiving peripheral device 1124 may extract, deserialize and otherwise process received transmissions to extract the VGI messages and other messages. Upon receipt of VGI messages and/or other types of messages, the VGI FSM 1126 or another component of the receiving device may interrupt its host processor to indicate receipt of messages and/or any changes in in GPIO signals.

In an example in which the communication link 1122 is provided as a serial bus, VGI messages and/or other types of messages may be transmitted in packets configured for an I2C, I3C, SPMI, RFFE or another standardized serial interface. In the illustrated example, VGI techniques are employed to accommodate I/O bridging between an Application Processor 1102 and a peripheral device 1124. The Application Processor 1102 may be provided in an ASIC, SoC, or in some combination of devices. The Application Processor 1102 includes a processor (central processing unit or CPU 1104) that generates messages to carry GPIO state associated with one or more communication channels 1106. VGI messages and/or other types of messages generated by the communication channels 1106 may be monitored by respective monitoring circuits 1112, 1114 in a VGI FSM 1126. In some examples, a GPIO monitoring circuit 1112 may be adapted to produce VGI messages representative of the state of physical GPIO and/or changes in the state of the physical GPIO. In some examples, other circuits are provided to produce the VGI messages representative of the state of physical GPIO and/or changes in the state of the physical GPIO.

An estimation circuit 1118 may be configured to estimate latency information that may be used to determine latency associated with the transmission of VGI messages using different communication links 1122 and/or protocols. The estimation circuit 1118 may select a protocol, and/or a mode of communication for the communication link 1122 that optimizes the latency for encoding and transmitting the GPIO signals and messages. In some implementations or instances, the estimation circuit 1118 may select a fixed table or programmable table that can be used to sort the traffic dynamically or configuration rate of notifications etc. The estimation circuit 1118 may maintain protocol and mode information 1116 that characterizes certain aspects of the communication link 1122 to be considered when selecting the protocol, and/or a mode of communication. The estimation circuit 1118 may be further configured to select a packet type for encoding and transmitting the GPIO state in VGI messages. The estimation circuit 1118 may provide configuration information used by a packetizer 1120 to encode the GPIO signals and messages. In one example, the configuration information is provided as a command that may be encapsulated in a packet such that the type of packet can be determined at a receiver. The configuration information, which may be a command, may also be provided to physical layer circuits (PHY 1108). The PHY 1108 may use the configuration information to select a protocol and/or mode of communication for transmitting the associated packet. The PHY 1108 may then generate the appropriate signaling to transmit the packet.

The peripheral device 1124 may include a VGI FSM 1126 that may be configured to process data packets received from the communication link 1122. The VGI FSM 1126 at the peripheral device 1124 may extract messages and may map bit positions in VGI messages onto physical GPIO pins in the peripheral device 1124. In certain embodiments, the communication link 1122 is bidirectional, and both the Application Processor 1102 and a peripheral device 1124 may operate as both transmitter and receiver.

The PHY 1108 in the Application Processor 1102 and a corresponding PHY 1128 in the peripheral device 1124 may be configured to establish and operate the communication link 1122. The PHY 1108 and 1128 may be coupled to, or include an RF transceiver 118 (see FIG. 1) that supports RF communications. In some examples, the PHY 1108 and 1128 may support a two-wire interface such an I2C, I3C, RFFE, SPMI, SMBus, or other interfaces in the Application Processor 1102 and in the peripheral device 1124, and VGI messages and/or other types of messages may be encapsulated in a packet transmitted over the communication link 1122, which may be a multi-drop serial or parallel bus, for example.

Certain aspects disclosed herein may be referred to as VGI tunneling. VGI tunneling can be implemented using existing or available protocols configured for operating the communication link 1122, and without the full complement of physical GPIO pins. VGI FSMs 1110, 1126 may exchange GPIO state information without the intervention of a CPU 1104 in the Application Processor 1102 and/or in the peripheral device 1124. The use of VGI messages can reduce pin count, power consumption, and latency associated with the communication link 1122.

At the receiving device, VGI messages are converted into physical GPIO state information. Certain characteristics of the physical GPIO pins may be configured using the VGI messages. For example, slew rate, polarity, drive strength, and other related parameters and attributes of the physical GPIO pins may be configured using the VGI messages. Configuration parameters used to configure the physical GPIO pins may be stored in configuration registers associated with corresponding GPIO pins. These configuration parameters can be addressed using a proprietary or conventional protocol such as I2C, I3C, SPMI or RFFE. In one example, configuration parameters may be maintained in addressable registers. Certain aspects disclosed herein relate to reducing latencies associated with the transmission of configuration parameters and corresponding addresses (e.g., addresses of registers used to store configuration parameters).

A VGI interface may enable transmission of VGI messages and/or other types of messages to be sent in a serial data stream over a communication link 1122. In one example, a serial data stream may include data encapsulated in packets, and the serial data stream may include a sequence of transactions conducted over a serial bus operated in accordance with an I2C, I3C, SPMI or RFFE protocol. The presence of VGI messages in a frame transmitted over the serial bus may be signaled using a special command code to identify the frame as a VGPIO frame. VGPIO frames may be transmitted as broadcast frames or addressed frames. In some implementations, a serial data stream may be transmitted in a form that resembles a universal asynchronous receiver/transmitter (UART) signaling protocol, in what may be referred to as VGI_UART mode of operation.

### Consolidating WCI-2 Messages Over a Multi-Drop Bus

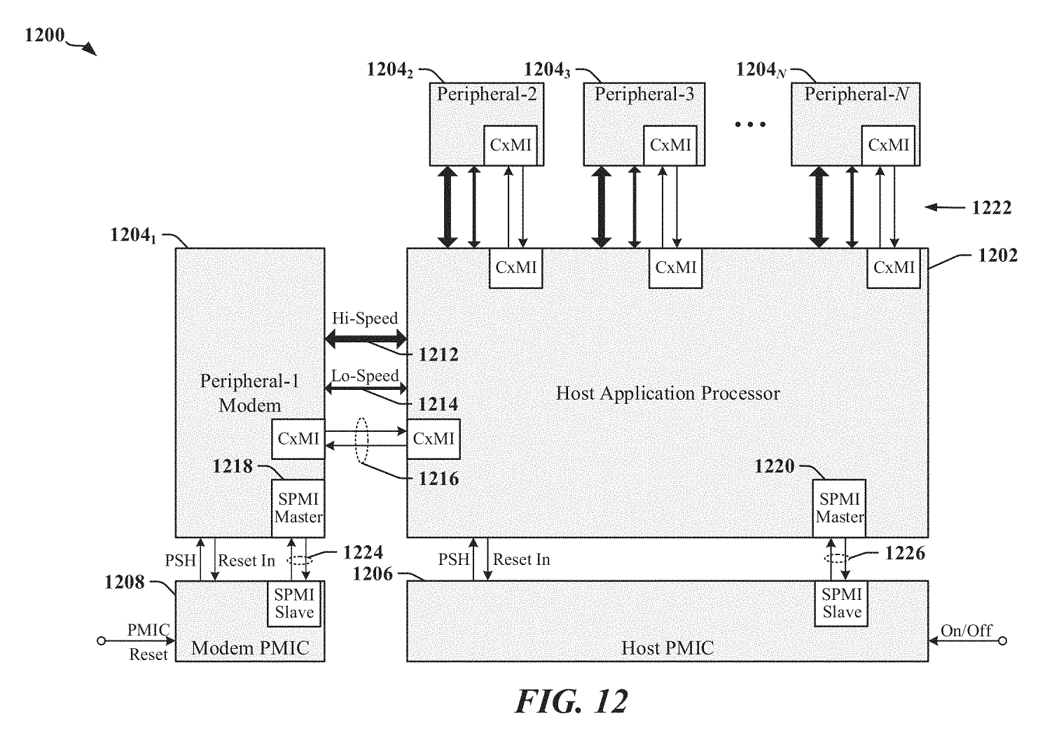

FIG. 12 illustrates an example of a system 1200 that includes multiple CxMi links. In some examples, it may be desirable to communicate WCI-2 messages over a single serial bus. In certain examples provided herein, an SPMI link 1224, 1226 may be adapted to carry WCI-2 messages, although the concepts described herein may be applied to a serial operated in accordance with an I2C, I3C, RFFE or other protocol. The system 1200 may include an application processor 1202 that may serve as a host device on various communication links, multiple peripherals 1204₁-1204_{N}, and one or more power management integrated circuits (PMICs 1206, 1208). In the illustrated system 1200, at least a first peripheral 1204₁ may include or operate as a modem. The application processor 1202 and the first peripheral 1204₁ may be coupled to respective PMICs 1206, 1208 using GPIO that provides a combination of reset and other signals, and one or more SPMI link s1224, 1226 that may be controlled by an SPMI master 1218, 1220. The SPMI link 1224, 1226 operates as a serial interface defined by the MIPI Alliance, and is optimized for the real-time control of devices including PMICs 1206, 1208. The SPMI link 1224, 1226 may be configured as a shared bus that provides high-speed, low-latency connection for multiple devices, where data transmissions may be managed according to priorities assigned to different traffic classes.

The application processor 1202 may be coupled to each of the peripherals 1204₁-1204_{N} using multiple communication links 1212, 1214, 1216, 1222, 1226 and GPIO. For example, the application processor 1202 may be coupled to the first peripheral 1204₁ using a high-speed bus 1212, a low-speed bus 1214 and a two-wire CxMi link 1216. As disclosed herein, WCI-2 messages that are conventionally transmitted using UARTs coupled to a CxMi link may be transferred through certain serial interfaces, including the SPMI masters 1218, 1220, an I2C or I3C interface, and/or an RFFE interface.

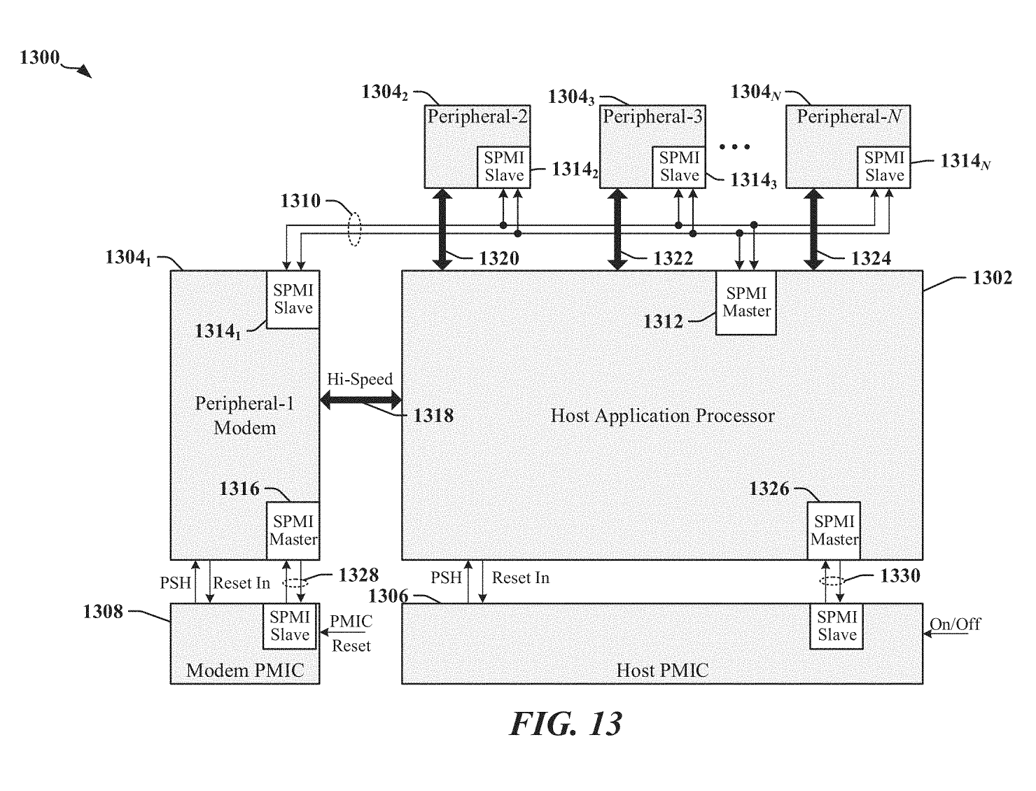

FIG. 13 illustrates an example of a system 1300 which can consolidate and communicate WCI-2 messages between multiple combinations of devices using one or more serial bus. In the illustrated example, a multi-drop serial bus 1310 operated in accordance with SPMI protocols may be used to WCI-2 messages between multiple devices, including for example a host application processor 1302 and peripherals 1304₁-1304_{N}. The WCI-2 protocol can be adjusted and generalized when tunneled over the multi-drop serial bus 1310. For example, the WCI-2 messages can be extended or expanded to form new messages.

The multi-drop serial bus 1310 may carry other traffic, including application data, virtualized state information for sideband GPIO associated with each high-speed serial link 1318, 1320, 1322, 1324, and other VGPIO associated with the host application processor 1302 and/or one or more of the peripherals 1304₁-1304_{N}, which may be transmitted in VGI messages over the multi-drop serial bus 1310. In one example, the host application processor 1302 may include an SPMI master 1312 and each of the peripherals 1304₁-1304_{N} may include SPMI slaves 1304₁-1304_{N}.

The system 1300 may include a host application processor 1302 that may serve as a host device on various communication links, including the multi-drop serial bus 1310. One or more power management integrated circuits (PMICs 1306, 1308) may be included in the system 1300 and may be coupled to the host application processor 1302 or peripheral devices 1304₁-1304_{N} through SPMI links 1328, 1330. The host application processor 1302 or peripheral devices 1304₁-1304_{N} may include an interface circuit 1316, 1326 that serves as a bus master on the corresponding SPMI link 1328, 1330. In the illustrated system 1300, at least a first peripheral 1304₁ includes a modem.

The multi-drop serial bus 1310 may be operated in accordance with SPMI protocols. Other protocols may be used for transferring WCI-2 messages at high speed, and with low latency. In one example, an RFFE bus may be employed for communicating WCI-2 messages. In another example, an I3C bus may be employed for communicating WCI-2 messages. As disclosed herein, GPIO signals may be virtualized and transferred over the multi-drop serial bus 1310. The transfer of the WCI-2 messages and/or virtualized GPIO signals may be accomplished without modifying the protocols used on the multi-drop serial bus 1310. In some examples, a finite state machine may be used to control the operation of the multi-drop serial bus 1310, including prioritizing messages.

A backbone link (e.g., the backbone link 916 of FIG. 9) may be provided and used to configure different information exchanges. A backbone link, which may exhibit longer latency, can be used to define how priority between different GPIOs or between different message sources is managed. The use of a backbone link permits the serial bus 1310 to be reserved for the exchange of core coexistence information and higher-level messages can be exchanged through the backbone link. In one example, the backbone link may be used to coordinate the host application processor 1302 and the peripherals 1304₁-1304_{N}, and may be used to configure formats and protocols for sending different types of messages. This allows the serial bus 1310 to guarantee a better variation in latency response as more clients are added to the system.

### Configurable WCI-2 Messaging

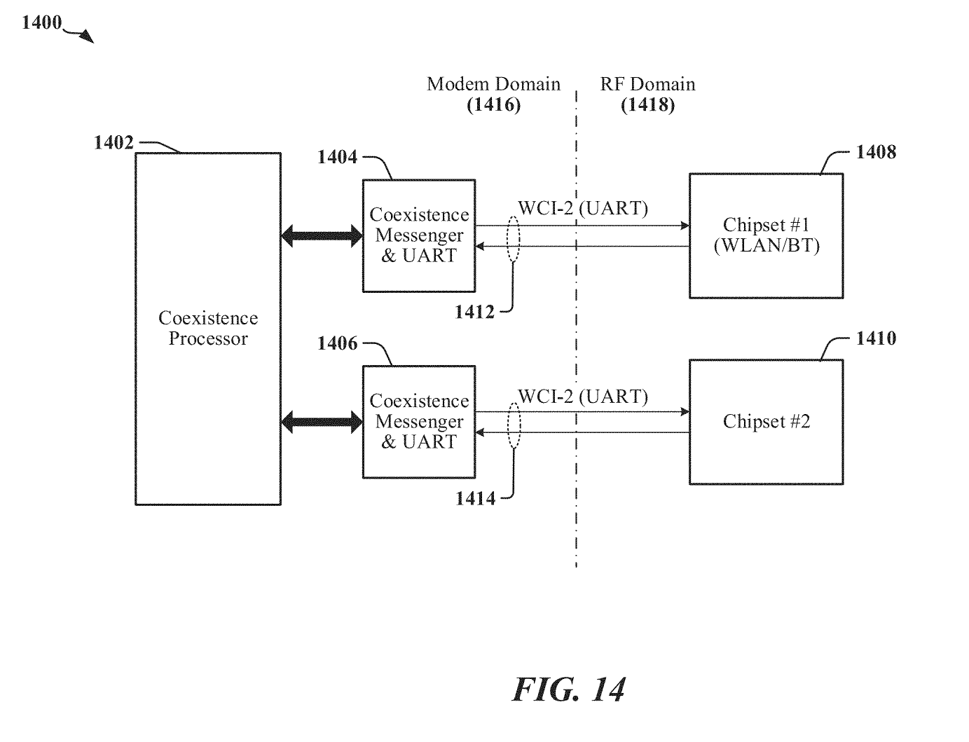

FIG. 14 illustrates an example of a conventional RF Co-Existence management architecture 1400 that may be implemented in a mobile device. The conventional RF Co-Existence management architecture 1400 may include multiple instances of low bandwidth point-to-point interfaces, typically implemented using a UART that exchanges low volume, low-latency coexistence information between devices. In one example, the coexistence information is transmitted as a single byte between a modem domain 1416 and an RF domain 1418. The RF domain 1418 may include one or more RF devices, which may include a WLAN/Bluetooth chipset 1408 and one or more other RF chipsets 1410. In the illustrated example, each RF chipset 1408, 1410 communicates with a corresponding coexistence messenger 1404, 1406 over a 2-wire (or 4-wire) point-to-point link 1412, 1414 implemented using UARTs provided in the RF chipsets 1408, 1410 and coexistence messengers 1404, 1406. The coexistence messengers 1404, 1406 may be managed and/or controlled by a coexistence processor 1402 or other controller, state machine, processor and/or algorithms that executes coexistence management software.

The use of point-to-point links 1412, 1414 consumes a large number of physical pins and interconnects. Package cost and printed circuit board complexity can be increased significantly in devices that support multiple RF interfaces. Package cost and printed circuit board complexity can be significantly reduced when coexistence messages are communicated over one or more high-speed multi-drop bus interfaces, including multi-drop serial buses that are used for other inter-device communication purposes.

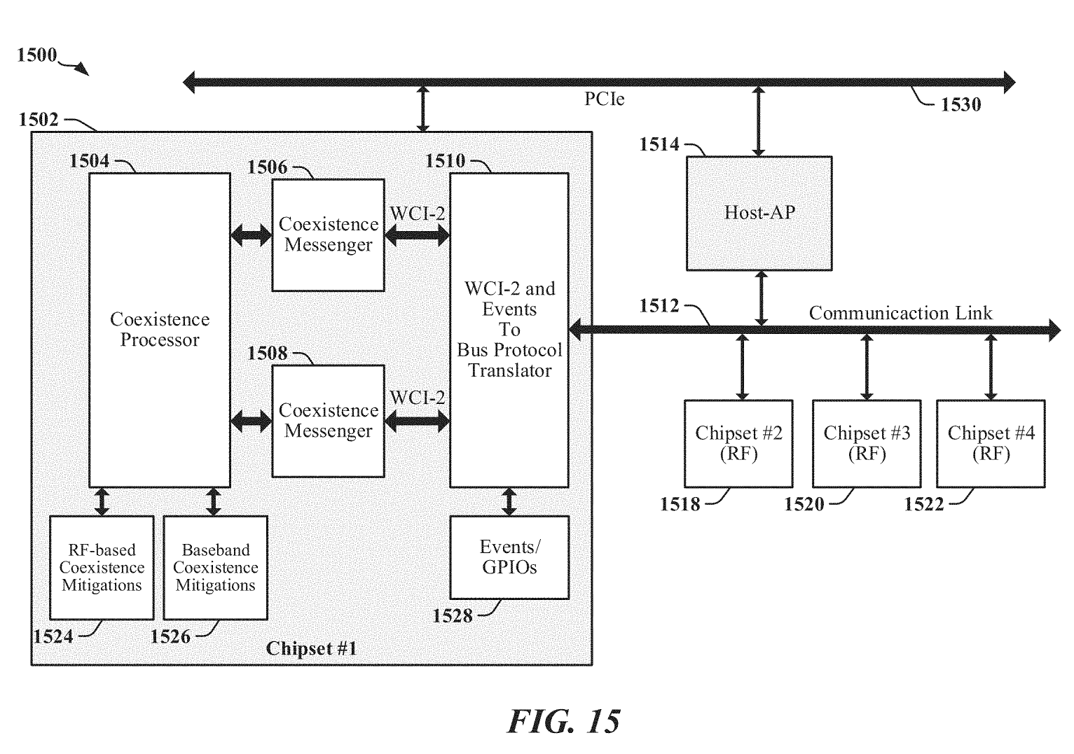

FIG. 15 illustrates a first example of a Co-Existence management architecture 1500 that may be implemented using a communication link 1512 deployed in a mobile device. The communication link 1512 may include one or more multi-drop serial buses operated in accordance with a protocol such as an RFFE, SPMI, I3C and/or other suitable protocol. In the example, a first chipset 1502, which may be operated as a modem for example, includes a coexistence processor 1504 configured receive and process RF-based coexistence mitigation information 1524 and baseband coexistence mitigation information 1526. In some instances, the coexistence processor 1504 generates coexistence messages and manages one or more coexistence messengers 1506, 1508. The coexistence messengers 1506, 1508 may be configured to handle messaging between the first chipset 1502 and at least one device and/or one or more RF chipsets 1518, 1520, 1522. In some implementations, the coexistence processor 1504 may include some combination of a controller, state machine, and/or processor with software modules that may include algorithms and instructions that cause the coexistence processor 1504 to perform coexistence management functions, such as adjusting RF transmission power, inhibiting transmissions for some period of time, accepting reduced signal quality for a period of time, etc. The RF chipsets 1518, 1520, 1522 or another device involved in coexistence management may also include a coexistence processor and/or coexistence messenger.

The coexistence messengers 1506, 1508 may generate WCI-2 messages for transmission to one or more RF chipsets 1518, 1520, 1522. The WCI-2 messages are provided to a translator 1510 that generates datagrams that can carry the coexistence messages over the communication link 1512. The datagrams may be configured in accordance with a protocol used to manage and control transmissions on a multi-drop serial bus of the communication link 1512. The coexistence messengers 1506, 1508 may receive WCI-2 messages from the translator 1510, where the received WCI-2 messages originate at one or more RF chipsets 1518, 1520, 1522. The coexistence messengers 1506, 1508 may decode received WCI-2 messages and forward the decoded messages as interrupts, requests and commands to the coexistence processor 1504. In some instances, the coexistence processor 1504 may exchange WCI-2 messages with a host application processor 1514. The host application processor 1514 may also include a coexistence processor and/or coexistence messenger. The host application processor 1514, RF chipsets 1518, 1520, 1522 or another device involved in coexistence management may also include a translator. In some implementations, the translator 1510 may receive event and GPIO information 1528 for transmission over the communication link 1512. For example, the event and GPIO information 1528 may include virtualized GPIO state information that the translator 1510 transforms or encapsulates in datagrams that can be transmitted over a multi-drop serial bus of the communication link 1512.

The communication link 1512 may include a multi-drop serial bus that is operated in accordance with protocols compliant or compatible with one or more standards-defined interfaces. In various examples, the multi-drop serial bus may be operated in accordance with an RFFE, SPMI, I3C or another protocol. In the illustrated Co-Existence management architecture 1500, the communication link 1512 is provided as a multi-drop serial bus operated in accordance with SPMI protocols. SPMI may be used when the multi-drop serial bus is used for other functions in an apparatus and has sufficient capability to support the exchange of coexistence messages. In some instances, the host application processor and the first chipset 1502 may be coupled to a system bus 1530. On or more of the chipsets 1518, 1520, 1522 may also be coupled to the system bus 1530.

The illustrated Co-Existence management architecture 1500 can reduce physical pin-count and printed circuit board complexity. In some instances, legacy devices included in an apparatus may not support the Co-Existence management architecture 1500. For example, it may be impractical to adapt certain legacy devices to transfer co-existence messages over the communication link 1512, or a legacy device may not have a serial bus that can provide the latency limitations imposed by transfer co-existence messages or latency may drive another bus.

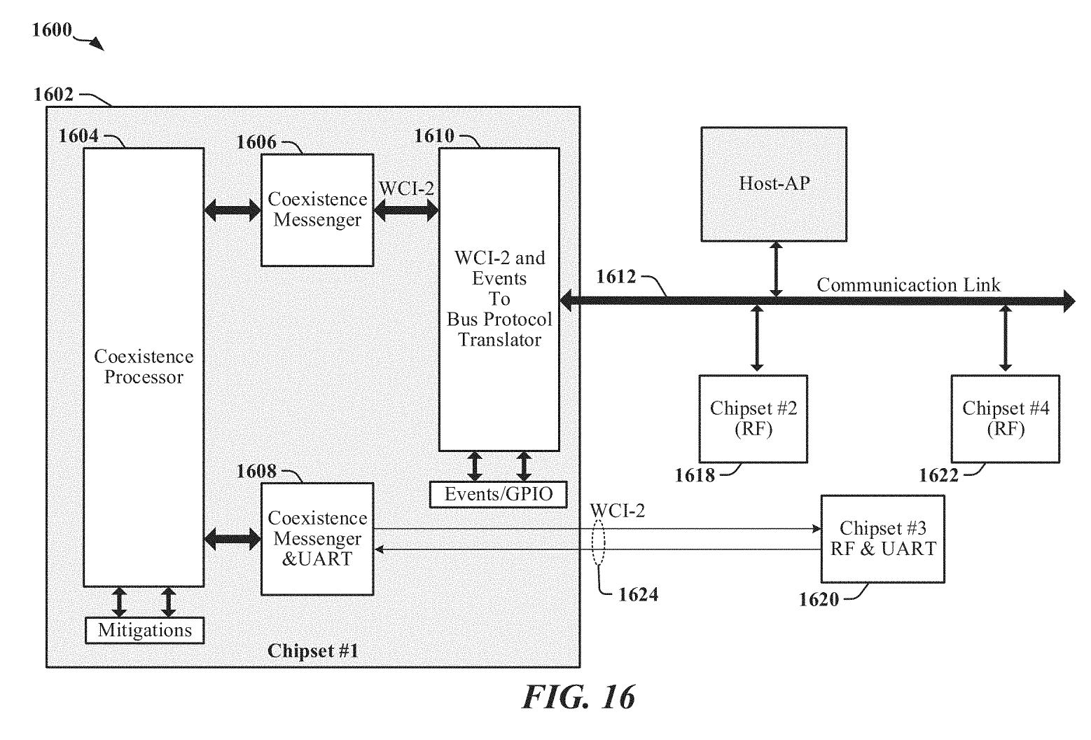

FIG. 16 illustrates a second example of a Co-Existence management architecture 1600 in which backward compatibility with legacy devices is provided in an apparatus adapted according to certain aspects disclosed herein. In the second example, the Co-Existence management architecture 1600 provides one or more point-to-point links 1624 and a communication link 1612 that may be used to exchange co-existence messages. The communication link 1612 may include one or more multi-drop serial buses operated in accordance with a protocol such as an RFFE, SPMI, I3C and/or other suitable protocol. A modem 1602 includes a coexistence processor 1604 configured to manage one or more coexistence messengers 1606, 1608. In some implementations, the coexistence processor 1604 may include some combination of a controller, state machine, processor with software modules that may include algorithms and instructions that cause the coexistence processor 1604 to perform coexistence management functions.

One or more coexistence messengers 1606, 1608 may generate WCI-2 messages for transmission to one or more RF chipsets 1618, 1620, 1622. In one example, a coexistence messenger 1606 generates WCI-2 messages addressed to one or more chipsets 1618, 1622, where these WCI-2 messages are provided to a translator 1610 that generates datagrams to carry the coexistence messages over the communication link 1612. The latter coexistence messenger 1606 may receive WCI-2 messages from the translator 1610, where the received WCI-2 messages originate at one or more RF chipsets 1618, 1622. In another example, a coexistence messenger 1608 includes a UART and transmits WCI-2 messages over a point-to-point link 1624 to a legacy chipset 1620. WCI-2 messages may be received from the point-to-point link 1624. The coexistence messengers 1606, 1608 may decode received WCI-2 messages and forward the decoded messages as interrupts, requests and commands to the coexistence processor 1604.

The Co-Existence management architecture 1600 of FIG. 16 facilitates migration to a co-existence management implementation based on a multi-drop serial bus while providing option to include legacy devices that require UART-based point-to-point links for co-existence management.

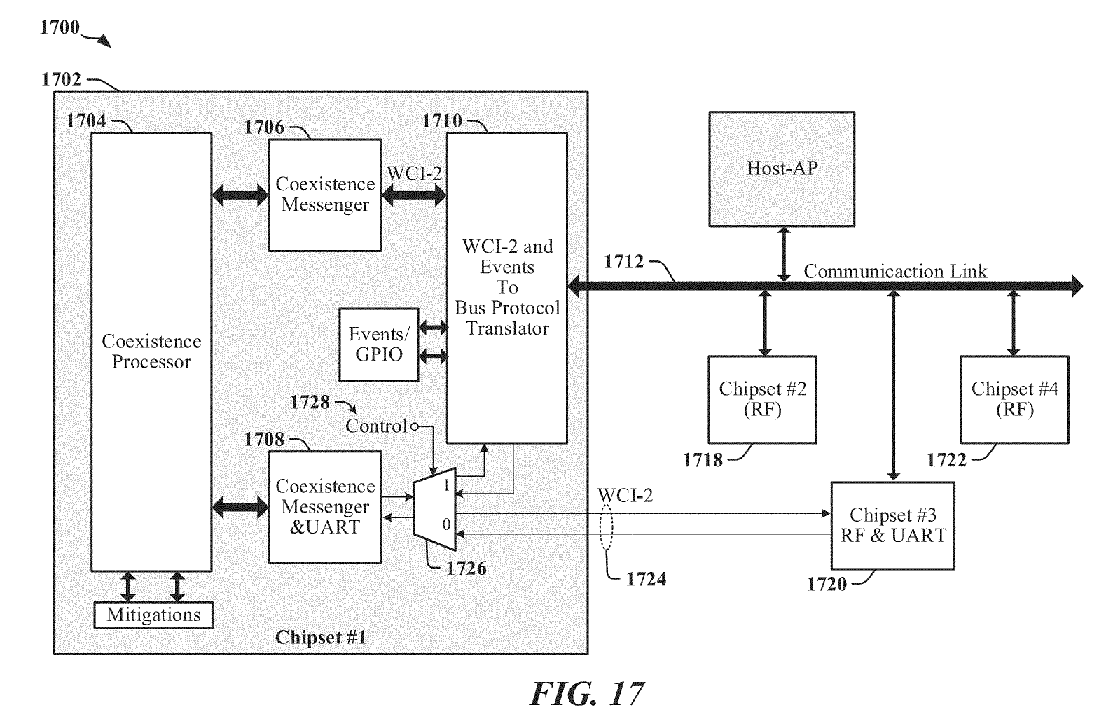

FIG. 17 illustrates a third example of a Co-Existence management architecture 1700 in which backward compatibility with legacy devices is selectable in an apparatus adapted according to certain aspects disclosed herein. In the third example, the Co-Existence management architecture 1700 provides GPIO to support one or more point-to-point links 1724 and a communication link 1712 that may be used to exchange co-existence messages. The communication link 1712 may include one or more multi-drop serial buses operated in accordance with a protocol such as an RFFE, SPMI, I3C and/or other suitable protocol. A modem 1702 includes a coexistence processor 1704 configured to manage one or more coexistence messengers 1706, 1708. In some implementations, the coexistence processor 1704 may include some combination of a controller, state machine, processor with software modules that may include algorithms and instructions that cause the coexistence processor 1704 to perform coexistence management functions.

One or more coexistence messengers 1706, 1708 may generate WCI-2 messages for transmission to one or more RF chipsets 1718, 1720, 1722. In one example, a coexistence messenger 1706 generates WCI-2 messages addressed to one or more chipsets 1718, 1720, 1722, where these WCI-2 messages are provided to a translator 1710 that generates datagrams to carry the coexistence messages over a multi-drop serial bus of the communication link 1712. In another example, a coexistence messenger 1708 includes a UART and may transmit WCI-2 messages over a point-to-point link 1724 to a legacy chipset 1720, and the coexistence messenger 1708 may provide the WCI-2 messages to the translator 1710 for transmission over the communication link 1712. A multiplexer 1726, switch or other selection logic may cooperate with the coexistence messenger 1708 to select between the point-to-point link 1724 and a multi-drop serial bus of the communication link 1712. Selection between the point-to-point link 1724 and the communication link 1712, which may be implemented as a multi-drop serial bus, and which may be controlled by a signal 1728 provided by some combination of the co-existence processor 1704, a controller, state machine or other processor, the translator 1710, and a configuration register.

The coexistence messengers 1706, 1708 may decode received WCI-2 messages and forward the decoded messages as interrupts, requests and commands to the coexistence processor 1704. The coexistence messengers 1706, 1708 may receive WCI-2 messages from the translator 1710, where the received WCI-2 messages originate at one or more RF chipsets 1718, 1720, 1722. When the point-to-point link 1724 path is selected, WCI-2 messages may be received from the point-to-point link 1724 and the coexistence messenger 1708 may decode received WCI-2 messages and forward the decoded messages as interrupts, requests and commands to the coexistence processor 1704.

The Co-Existence management architecture 1700 of FIG. 17 facilitates migration to a co-existence management implementation based on a multi-drop serial bus while providing flexibility to include legacy devices that require UART-based point-to-point links for co-existence management. The Co-Existence management architecture 1700 of FIG. 17 enables an apparatus to select a path for co-existence messages based on characteristics of available links 1712, 1724, including latency, utilization and other characteristics.

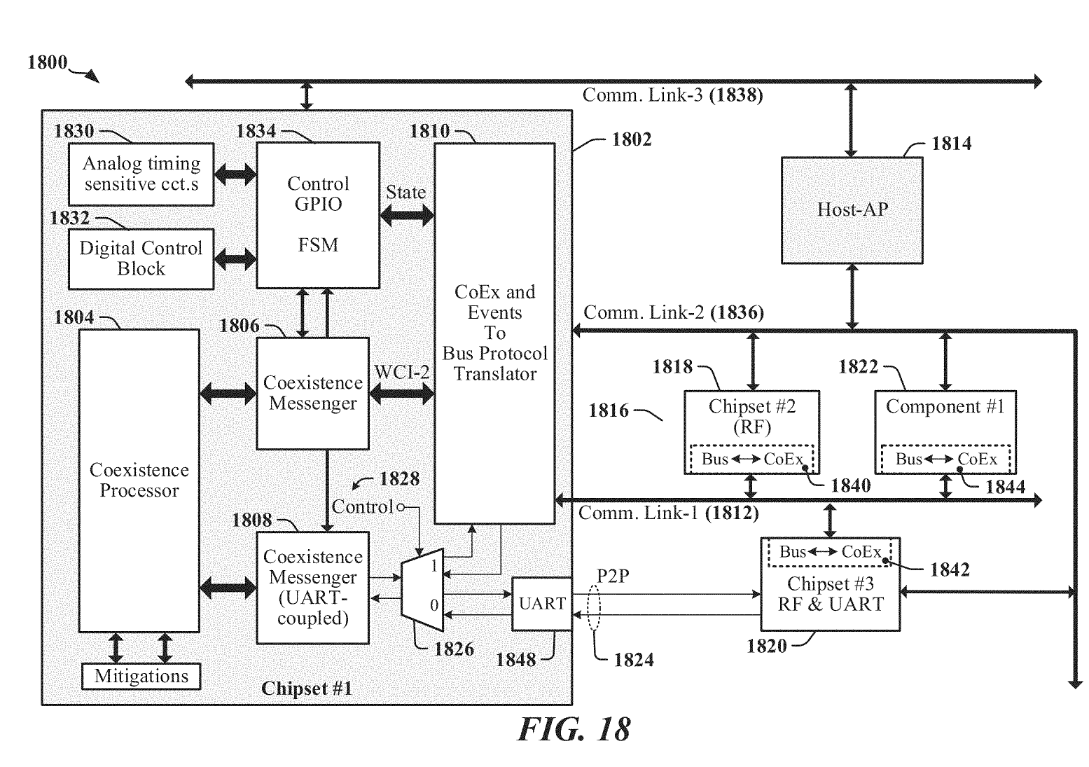

FIG. 18 illustrates a fourth example of a Co-Existence management architecture 1800 in which multiple sources of coexistence information are supported and a path for co-existence messages may be selected based on application needs, devices configurations and/or types of chipsets and devices to be supported by an apparatus that implements the Co-Existence management architecture 1800. The Co-Existence management architecture 1800 can also provide backward compatibility with legacy devices.

In the fourth example, the Co-Existence management architecture 1800 provides physical GPIO to support one or more multi-drop communication links 1812, 1836, 1838 that may be used to exchange co-existence messages with one or more chipsets 1818, 1820 and/or RF components 1822. An RF component 1822 may function as an LNA, Switch Power Amplifier, etc. and may be configured to be coupled to at least one communication link 1812, 1824, 1836, 1838. In the illustrated example, a point-to-point communication link 1824 supports direct, low-volume UART-based data transmissions between a first chipset 1802 and a second chipset 1816. A first multi-drop communication link 1812, which may couple multiple chipsets 1802, 1818, 1820 and/or one or more RF components 1822, may be used for the exchange of coexistence messages. The first multi-drop communication link 1812 includes at least one serial bus operated in accordance with a standards-defined or proprietary communication protocol, such as the SPMI, RFFE and/or I3C protocols. In some instances, coexistence, command and control traffic may be apportioned among two or more multi-drop serial buses included in the first multi-drop communication link 1812.

A second multi-drop communication link 1836 may be provided to couple two or more chipsets 1802, 1818, 1820 and/or one or more RF components 1822 with other types of device, including an application processor 1814, for example. The second multi-drop communication link 1836 may also be used to exchange coexistence messages and to configure the chipsets 1802, 1818, 1820 and/or RF components 1822. The second multi-drop communication link 1836 may include at least one serial bus operated in accordance with a standards-defined or proprietary communication protocol, such as the SPMI, RFFE and/or I3C protocols. One or more of the chipsets 1802, 1818, 1820 and the application processor 1814 may be coupled to a third multi-drop communication link 1838. The third multi-drop communication link 1838 may be operated as a system bus.

The first chipset 1802 may be representative of one or more other chipsets 1818, 1820. In various examples, the first chipset may be a modem or RF transceiver. In some instances, two or more chipsets 1818, 1820 and/or RF components 1822 may be provided in a single chipset 1816. The first chipset 1802 may include circuits or modules 1840, 1842, 1844 that translate between bus protocols and coexistence messages and between coexistence messages and bus protocols. In some instances, the coexistence messages may be initially formatted according to WC-2 protocols. The point-to-point communication links 1824 and multi-drop communication links 1812, 1836 may offer a selection of latency, command structure, datagram structure, overhead and other characteristics that can influence selection of a pathway for co-existence messages. For example, an I3C bus may provide advantages when larger data payloads are transferred while an RFFE bus or SPMI bus may be better suited for transporting small datagrams in some implementations. In another example, one or more of the chipsets 1802, 1818, 1820 and/or RF components 1822 may support a multi-drop serial protocol that is not supported by the other chipsets 1802, 1818, 1820 and/or RF components 1822 and a combination of multi-drop serial buses and/or point-to-point communication links 1824 may be configured for transporting coexistence messages.

In FIG. 18, the first chipset 1802 includes a coexistence processor 1804 configured to manage one or more coexistence messengers 1806, 1808. In some implementations, the coexistence processor 1804 may include some combination of a controller, state machine, processor with software modules that may include algorithms and instructions that cause the coexistence processor 1804 to perform coexistence management functions.

One or more coexistence messengers 1806, 1808 may generate coexistence messages for transmission to one or more chipsets 1818, 1820 and/or RF components 1822. In one example, a coexistence messenger 1806 generates WCI-2 messages addressed to one or more of the other chipsets 1818, 1820 and/or an RF component 1822. The messages generated by the coexistence messengers 1806, 1808 may be provided to a translator 1810 that generates datagrams to carry the coexistence messages over one or more multi-drop communication links 1812, 1836, 1838 in accordance with a corresponding bus protocol. In another example, a coexistence messenger 1808 may include a UART or be coupled to a UART 1848. In one mode of operation, the coexistence messenger 1808 may transmit WCI-2 messages through the UART 1848 over a point-to-point communication link 1824 to a chipset 1820. In another mode of operation, the coexistence messenger 1808 may provide the WCI-2 messages to the translator 1810 for transmission over one or more multi-drop communication links 1812, 1836, 1838. A multiplexer 1826, switch or other selection logic may cooperate with the coexistence messenger 1808 to dynamically or statically select between the point-to-point communication link 1824 and the multi-drop communication link 1812, for example. Static configuration of the multiplexer 1826 may be employed to support a legacy device or chipset 1820 that does not support an appropriate or suitable multi-drop serial bus protocol, or in an application that anticipates that use of a point-to-point communication link 1824 as a necessity. Selection between the point-to-point communication link 1824 and one of the multi-drop communication links 1812, 1836, 1838 for communicating WCI-2 messages may be controlled by a signal 1828 provided by some combination of the co-existence processor 1804, a controller, state machine (VGI FSM 1834) or other processor, the translator 1810, and a configuration register.

The coexistence messengers 1806, 1808 may decode received WCI-2 messages and forward the decoded messages as interrupts, requests and commands to the coexistence processor 1804. The coexistence messengers 1806, 1808 may receive WCI-2 messages from the translator 1810, where the received WCI-2 messages originate at one or more chipsets 1818, 1820 and/or RF components 1822. When the point-to-point communication link 1824 path is selected, WCI-2 messages may be received from the point-to-point communication link 1824 and the coexistence messenger 1808 may decode received WCI-2 messages and forward the decoded messages as interrupts, requests and commands to the coexistence processor 1804 and/or a VGI FSM 1834.

The VGI FSM 1834 may be provided to manage virtualization of physical GPIO state to obtain Virtual GPIO state (VGPIO) and conversion of received VGPIO to physical GPIO state. Virtual GPIO state (VGPIO) may be transmitted in datagrams over one or more of the multi-drop communication links 1812, 1836, 1838. The VGI FSM 1834, coexistence processor 1804 and/or coexistence messengers 1806, 1808 may cooperate to determine allocation of the multi-drop communication links 1812, 1836. For example, an I3C bus may be reserved for transmitting datagrams containing VGPIO. In another example, latency characteristics may be used to allocate multi-drop serial links 1812, 1836 and/or point-to-point communication links 1824 among different types of traffic.

In some instances, the VGI FSM 1834 may receive GPIO state information and/or priority messages or signals from a variety of sources. In one example, the VGI FSM 1834 may manage processing of timing-sensitive analog state 1830. In another example, the VGI FSM 1834 may manage processing of digital sources 1832 of state, including alerts, interrupts, events and other software or processor-generated signals. The VGI FSM 1834 may receive VGI messages directed to analog and digital consumers of virtualized GPIO state and control signals.

In some implementations, the translator 1810 may include a programmable core that permits simultaneous support of multiple types of multi-drop communication links 1812, 1836. The programmable core may configure multi-drop communication links 1812, 1836 to operate in accordance with different types of protocols. In some instances, two or more multi-drop serial buses may be configured to operate independently in accordance with the same type of protocol.

The translator 1810 may be configured to monitor bus interfaces and UARTs that engage in exchange of coexistence management information. In one example, the translator 1810 may determine and/or select a multi-drop communication link 1812, 1836 to be used for communicating coexistence management information. The translator 1810 may, in some instances, cause a coexistence messenger 1808 to direct coexistence information over the point-to-point communication link 1824. In another example, the translator 1810 may be configured to identify when the bus interfaces and UARTs are in power-down mode. In some instances, the translator 1810 may power-down, at least partially and may cause one or more coexistence messengers 1806, 1808 to power down.

The Co-Existence management architecture 1800 of FIG. 18 provides a versatile and dynamically reconfigurable environment that supports co-existence management and virtualization of GPIO. Some implementations can overlap functionality whereby, for example, a UART-based point-to-point communication link 1824 may be virtualized and WCI-2 messages may be effectively communicated using VGPIO. The Co-Existence management architecture 1800 of FIG. 18 enables an apparatus latitude to select a path for co-existence messages from a variety of physical and virtual links and/or protocols to meet application-specific latency, capacity, throughput and other characteristics.

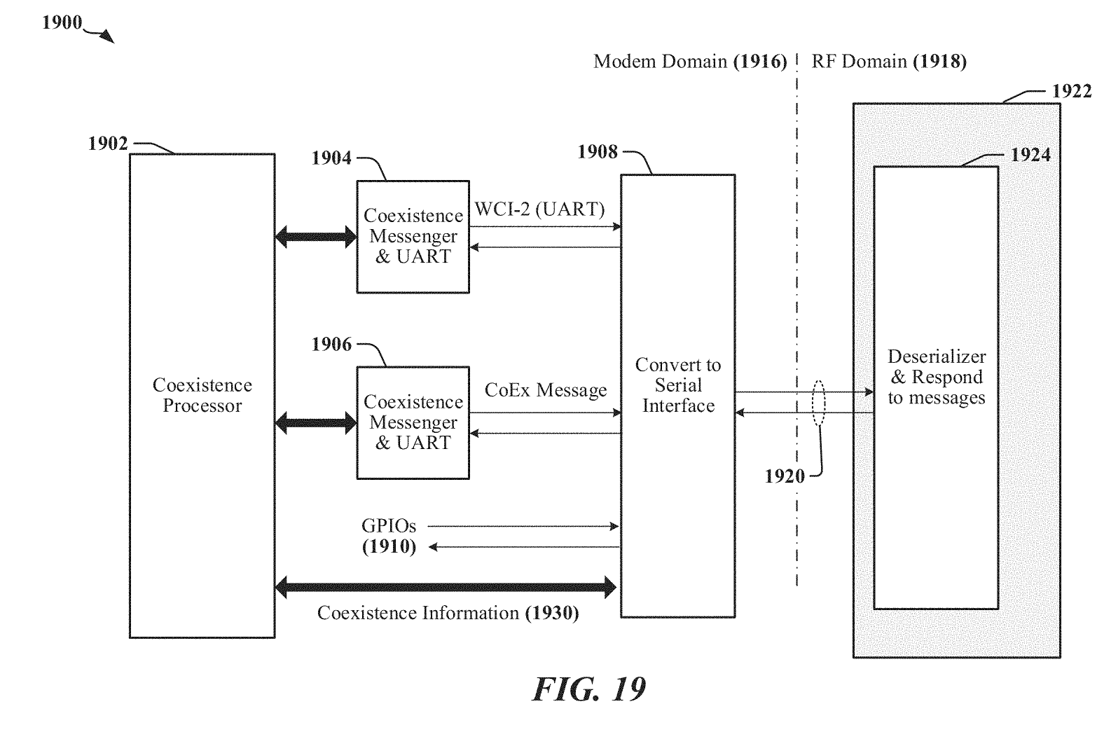

FIG. 19 illustrates certain operational aspects of a Co-Existence management architecture 1900 provided in accordance with certain aspects disclosed herein. In a modem domain 1916, a coexistence processor 1902 may generate coexistence information. The coexistence processor 1902 may provide certain coexistence information to one or more coexistence messengers 1904, 1906. A first coexistence messenger 1904 may provide coexistence messages to a converter 1908 that transmits the coexistence messages in datagrams that can be transmitted over a multi-drop serial bus 1920. Some coexistence messengers 1906 may provide coexistence messages to the converter 1908 in accordance with the WCI-2 protocol, or a modified form of the WCI-2 protocol. WCI-2 coexistence messages can be transmitted over a point-to-point bus using a UART. In some instances, WCI-2 coexistence messages may be provided in datagrams that can be transmitted over the multi-drop serial bus 1920. In some implementations, the coexistence processor 1902 may provide coexistence information 1930 directly to the converter 1908, and the converter 1908 may translate the coexistence information to one or more coexistence messages that can be transmitted over the multi-drop serial bus 1920. Coexistence information can be obtained from physical GPIO state information. The converter 1908 may receive GPIO state 1910 and, in one mode, the converter 1908 may generate one or more coexistence messages from the GPIO state 1910 that can be transmitted over the multi-drop serial bus 1920. In a second mode, the GPIO state 1910 may be virtualized and transmitted over the multi-drop serial bus 1920 in VGI packets.

At the receiver 1922, which may be deployed in an RF domain 1918, a deserializer 1924 may receive serialized messages from the multi-drop serial bus 1920. The deserializer 1924 may determine appropriate or desired response to received coexistence state information. In some instances, the deserializer 1924 may communicate a response back through the multi-drop serial bus 1920. In some instances, the deserializer 1924 may initiate mitigation in response to received coexistence information. Mitigation may be initiated by manipulating physical GPIO state, configuring one or more RF components and/or modifying a mode of operation of one or more RF components.

### Example of Memory Mapping for Coexistence Management

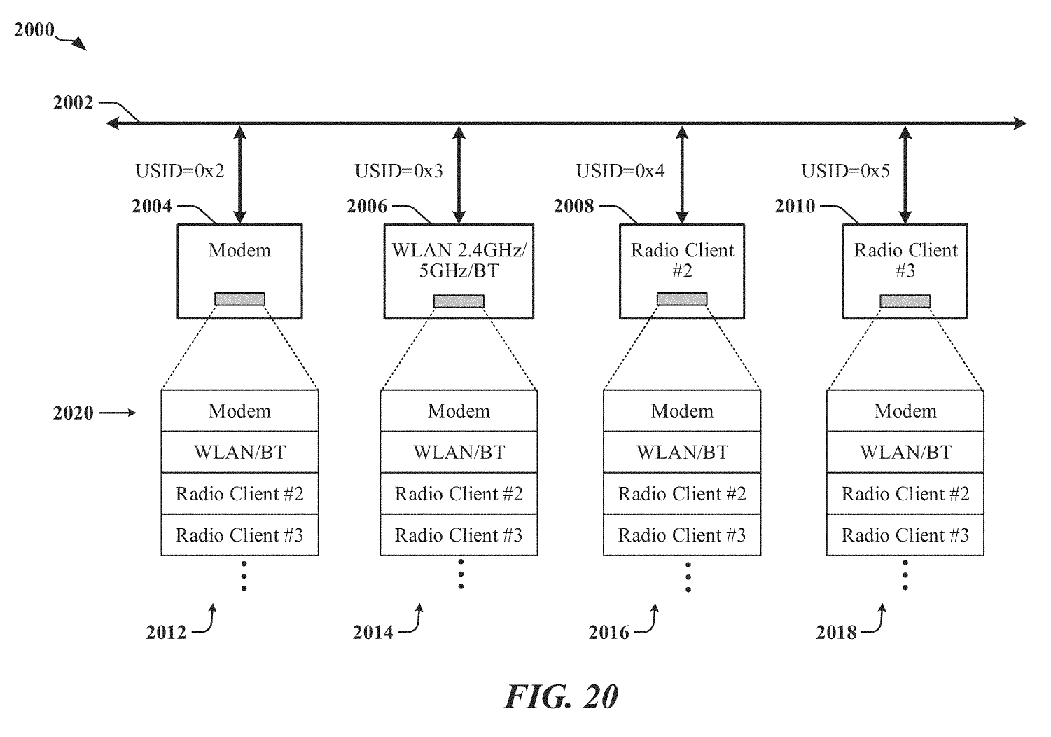

FIG. 20 illustrates an example of a memory configuration 2000 that may be employed in certain Co-Existence management architectures 1500, 1600, 1700, 1800. Each device 2004, 2006, 2008, 2010 that is coupled to a serial bus 2002 and that may exchange coexistence management messages may be configured with a common memory map 2012, 2014, 2016, 2018 that reserves a block of registers or memory locations for each of the devices 2004, 2006, 2008, 2010 that may participate in coexistence management. Any of the devices 2004, 2006, 2008, 2010 may write, read or update coexistence management information in another device 2004, 2006, 2008, 2010. In one example, a modem device 2004 may write to the modem segment 2020 of a first radio client 2006 and a second radio client 2008 where, for example, the first radio client 2006 supports WLAN and/or Bluetooth communication and the second radio client 2008 includes or supports a near-field communication device. In another example, the modem device 2004 may write to the modem segment 2020 in each of the other devices 2006, 2008, 2010. Each device 2006, 2008, 2010 written by the modem 2004 may then process the received data in accordance with internal protocols and/or configurations.

The addressing scheme and data payload definitions for datagrams used to write to the common memory map 2012, 2014, 2016, 2018 may be defined by application needs, protocols used on the serial bus 2002 and other design requirements.

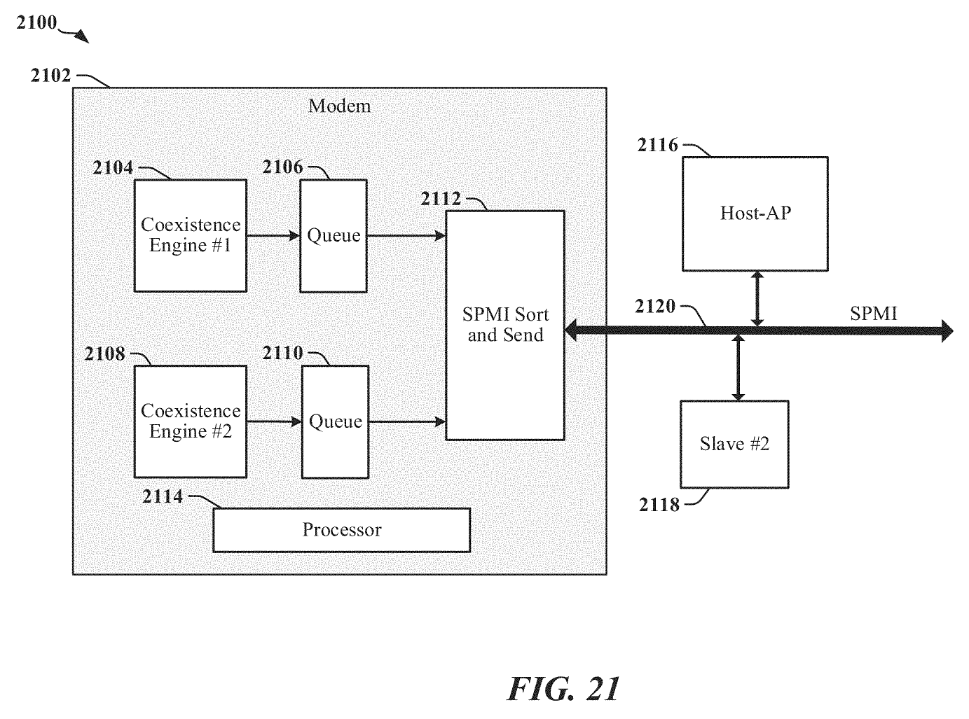

FIG. 21 illustrates an example of sort/priority processing 2100. A scheduling circuit 2112 configured to perform sort and priority processing may employ a sorting table based on a priority action dictated by the processor 2114 of a peripheral 2102 (e.g., a modem) when contention exists between multiple coexistence engines 2104, 2108 that concurrently produce high-priority messages to be transmitted over a multi-drop serial bus 2120. In some instances, coexistence messages are maintained in queues 2106, 2110. In one example, the multi-drop serial bus 2120 may be operated in accordance with an SPMI protocol. In other examples, the multi-drop serial bus 2120 may be operated in accordance with an I2C, I3c, RFFE, CxMi, or other protocol. Peripherals 2102, 2118 may communicate information related to sorting and/or prioritizing transmissions through a backbone communication link to the processor 2114 of the modem 2102. Information related to sorting and/or prioritizing transmissions may include or relate to the priority tables. In some instances, the baseband processor 2116 can continue slow background communication of new or upcoming events such that a real time response can be configured between peripherals 2102, 2118. The peripherals 2102, 2118 and a baseband processor 2116 can respond to received messages in the manner defined by configuration.

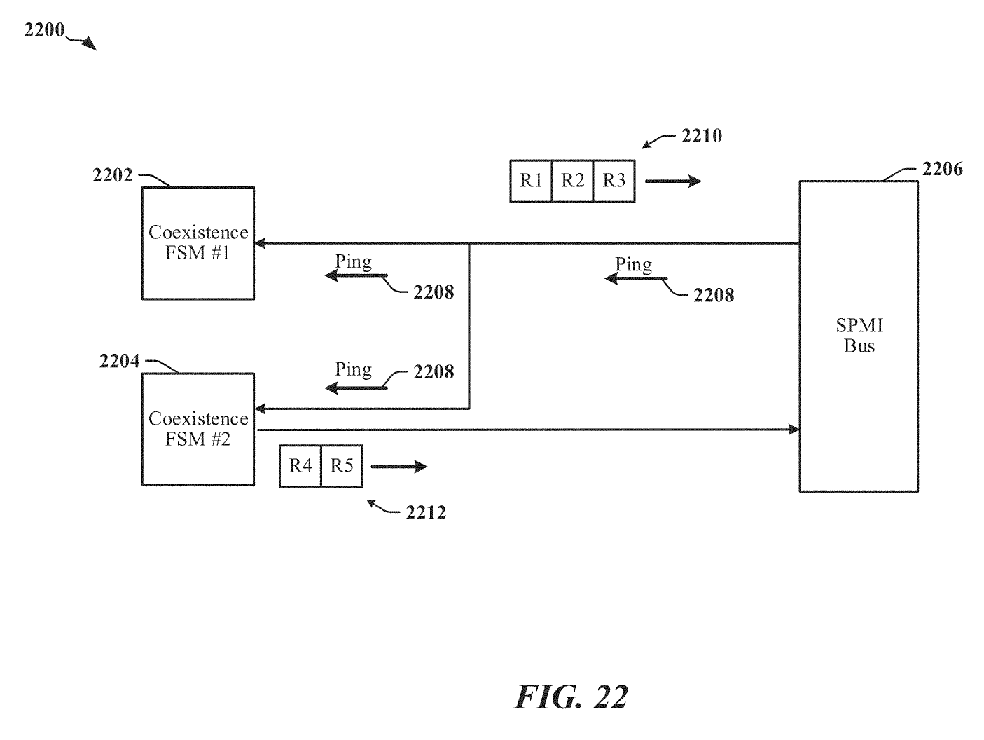

FIG. 22 illustrates an example 2200 in which multiple active sources are processed by finite state machines (FSMs 2202, 2204). The FSMs 2202, 2204 may generate coexistence messages that indicate state of RF components, events and/or existence of detected coexistence problems in a client device. Sorting may be performed on the different messages generated by the FSMs 2202, 2204, based on the nature of the active coexistence sources 2202, 2204, system configuration, and/or certain types message that may be pending access to the SPMI bus 2206 used for communicating coexistence information. The most critical pending messages may be prioritized for transmission over the SPMI bus 2206 to manage the real-time response required for coexistence activities. In one example, a response to a received ping message 2208 may be sent as a message 2210, 2212 returned over the SPMI bus 2206 to inform the status of all the active technologies available on the client. Returned ping messages 2210, 2212 may be combined in a manner that increase transmission efficiency and/or reduces latency.

In some instances, a client coupled to the SPMI bus 2206 that is preparing to enter a sleep state may transmit messages to notify other clients coupled to the SPMI bus 2206 of the entry to sleep state. The notification of entry to sleep state may reduce or eliminate NACK messages on the SPMI bus 2206 and attempts by an application processor to retry transmissions when the client is in an inactive state. When the inactive client wakes up or otherwise becomes active on the SPMI bus 2206, it may transmit out messages to notify messages to notify other clients coupled to the SPMI bus 2206 of its availability on the SPMI bus 2206.

### Examples of Processing Circuits and Methods

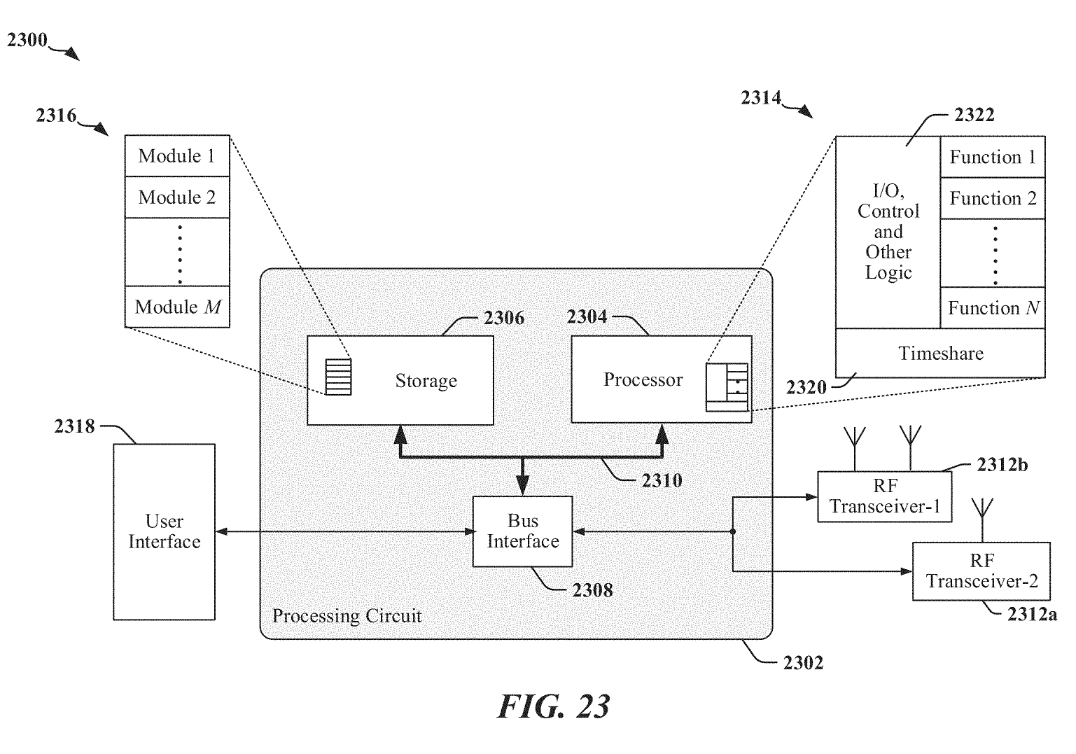

FIG. 23 is a diagram illustrating an example of a hardware implementation for an apparatus 2300 employing a processing circuit 2302. The processing circuit 2302 may include or configure the operation of a finite state machine 1110 (see FIG. 11). In some examples, the apparatus 2300 may perform one or more functions disclosed herein. In accordance with various aspects of the disclosure, an element, or any portion of an element, or any combination of elements as disclosed herein may be implemented using a processing circuit 2302. The processing circuit 2302 may include one or more processors 2304 that are controlled by some combination of hardware and software modules. Examples of processors 2304 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 2304 may include specialized processors that perform specific functions, and that may be configured, augmented or controlled by one of the software modules 2316. The one or more processors 2304 may be configured through a combination of software modules 2316 loaded during initialization, and further configured by loading or unloading one or more software modules 2316 during operation.

In the illustrated example, the processing circuit 2302 may be implemented with a bus architecture, represented generally by the bus 2310. The bus 2310 may include any number of interconnecting buses and bridges depending on the specific application of the processing circuit 2302 and the overall design constraints. The bus 2310 links together various circuits including the one or more processors 2304, and storage 2306. Storage 2306 may include memory devices and mass storage devices and may be referred to herein as computer-readable media and/or processor-readable media.

The bus 2310 may also link various other circuits such as timing sources, timers, peripherals, voltage regulators, and power management circuits. A bus interface 2308 may provide an interface between the bus 2310 and one or more RF transceivers 2312a, 2312b. An RF transceiver 2312a, 2312b may be provided for each networking technology supported by the processing circuit. In some instances, multiple networking technologies may share some or all of the circuitry or processing modules found in an RF transceiver 2312a, 2312b. Each RF transceiver 2312a, 2312b provides a means for communicating with various other apparatus over a transmission medium. In one example, each RF transceiver 2312a, 2312b may be used to connect the apparatus 2300 to a radio access network. Depending upon the nature of the apparatus 2300, a user interface 2318 (e.g., keypad, display, speaker, microphone, joystick) may also be provided, and may be communicatively coupled to the bus 2310 directly or through the bus interface 2308.

A processor 2304 may be responsible for managing the bus 2310 and for general processing that may include the execution of software stored in a computer-readable medium that may include the storage 2306. In this respect, the processing circuit 2302, including the processor 2304, may be used to implement any of the methods, functions and techniques disclosed herein. The storage 2306 may be used for storing data that is manipulated by the processor 2304 when executing software, and the software may be configured to implement any one of the methods disclosed herein.

One or more processors 2304 in the processing circuit 2302 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2306 or in an external computer-readable medium. The external computer-readable medium and/or storage 2306 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 2306 may also include, by way of example, a carrier wave, a transmission line, and any other suitable medium for transmitting software and/or instructions that may be accessed and read by a computer. Computer-readable medium and/or the storage 2306 may reside in the processing circuit 2302, in the processor 2304, external to the processing circuit 2302, or be distributed across multiple entities including the processing circuit 2302. The computer-readable medium and/or storage 2306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 2306 may maintain software maintained and/or organized in loadable code segments, modules, applications, programs, etc., which may be referred to herein as software modules 2316. Each of the software modules 2316 may include instructions and data that, when installed or loaded on the processing circuit 2302 and executed by the one or more processors 2304, contribute to a run-time image 2314 that controls the operation of the one or more processors 2304. When executed, certain instructions may cause the processing circuit 2302 to perform functions in accordance with certain methods, algorithms and processes described herein.

Some of the software modules 2316 may be loaded during initialization of the processing circuit 2302, and these software modules 2316 may configure the processing circuit 2302 to enable performance of the various functions disclosed herein. For example, some software modules 2316 may configure internal devices and/or logic circuits 2322 of the processor 2304 and may manage access to external devices such as an RF transceiver 2312a, 2312b, the bus interface 2308, the user interface 2318, timers, mathematical coprocessors, and so on. The software modules 2316 may include a control program and/or an operating system that interacts with interrupt handlers and device drivers, and that controls access to various resources provided by the processing circuit 2302. The resources may include memory, processing time, access to the RF transceiver 2312a, 2312b, the user interface 2318, and so on.

One or more processors 2304 of the processing circuit 2302 may be multifunctional, whereby some of the software modules 2316 are loaded and configured to perform different functions or different instances of the same function. The one or more processors 2304 may additionally be adapted to manage background tasks initiated in response to inputs from the user interface 2318, the transceiver 2312a, 2312b, and device drivers, for example. To support the performance of multiple functions, the one or more processors 2304 may be configured to provide a multitasking environment, whereby each of a plurality of functions is implemented as a set of tasks serviced by the one or more processors 2304 as needed or desired. In one example, the multitasking environment may be implemented using a timesharing program 2320 that passes control of a processor 2304 between different tasks, whereby each task returns control of the one or more processors 2304 to the timesharing program 2320 upon completion of any outstanding operations and/or in response to an input such as an interrupt. When a task has control of the one or more processors 2304, the processing circuit is effectively specialized for the purposes addressed by the function associated with the controlling task. The timesharing program 2320 may include an operating system, a main loop that transfers control on a round-robin basis, a function that allocates control of the one or more processors 2304 in accordance with a prioritization of the functions, and/or an interrupt driven main loop that responds to external events by providing control of the one or more processors 2304 to a handling function.

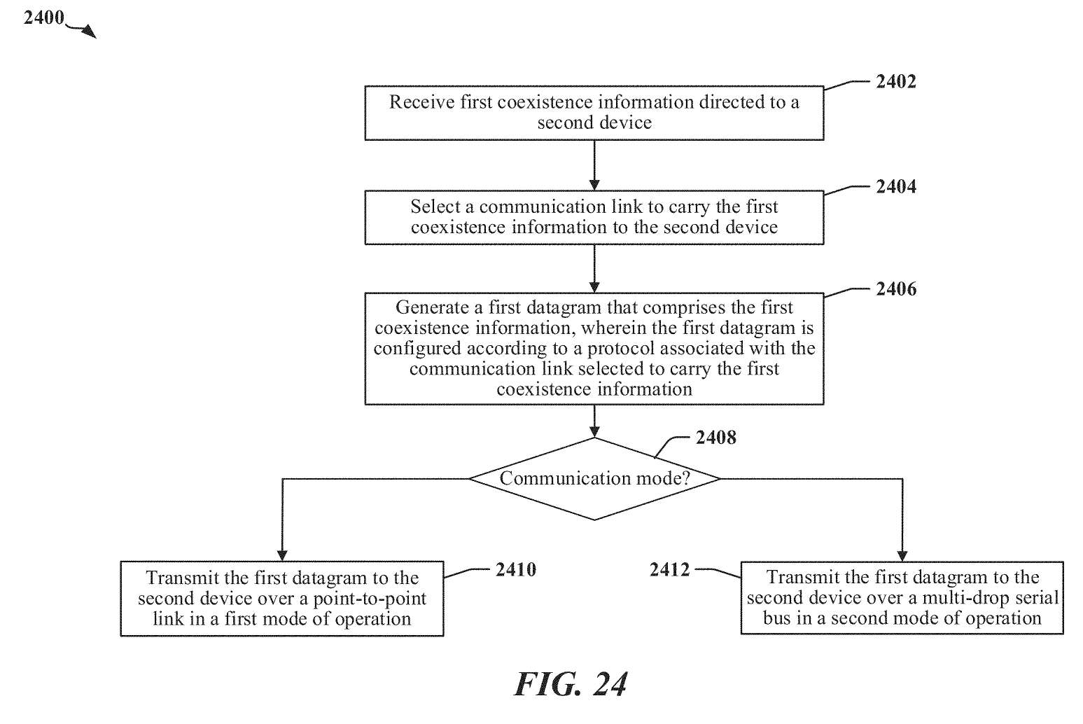

FIG. 24 is a flowchart 2400 of a method that may be performed at a first device coupled to a serial bus. In various examples, the device may include one or more chipsets and may operate as a modem or an RF transceiver. At block 2402, the device may receive first coexistence information directed to a second device. At block 2404, the device may select a communication link to carry the first coexistence information to the second device. At block 2406, the device may generate a first datagram that includes the first coexistence information. The first datagram may be configured according to a protocol associated with the communication link selected to carry the first coexistence information. At block 2408, the device may select a mode of communication for the transmitting the first datagram. At block 2410, the device may transmit the first datagram to the second device over a point-to-point link in a first mode of operation. At block 2412, the device may transmit the first datagram to the second device over a multi-drop serial bus in a second mode of operation. In one example, the first datagram is communicated through a UART in the first mode of operation.

In certain examples, the device may receive second coexistence information directed to a third device coupled to the first device, generate a second coexistence message representative of the second coexistence information, and transmit a second datagram to the third device over a communication link selected to carry the second coexistence information. The second coexistence information may be configured for communication through a point-to-point data link.

In one example, the device may receive third coexistence information directed to a first radio frequency component coupled to the multi-drop serial bus, and generate a third coexistence message representative of the third coexistence information. The third coexistence message may be transmitted in accordance with the second mode of operation.

In some examples, the device may generate fourth coexistence information representative of signaling state of a physical GPIO pin, and generate a fourth coexistence message that includes the fourth coexistence information. The fourth coexistence message may be transmitted in accordance with the second mode of operation. The fourth coexistence message may include virtualized GPIO.

In one example, the coexistence information is received concurrently from two or more sources, and the device may use a sorting table to determine an order of transmission for coexistence messages that includes the coexistence information received concurrently from the two or more sources.

In some implementations, the multi-drop serial bus is one of a plurality of serial buses coupled to the first device, and the device may select the multi-drop serial bus from among the plurality of serial buses to carry the first coexistence information based on one or more characteristics of a protocol associated with the multi-drop serial bus. The one or more characteristics of the protocol may include bus latency and/or bus capacity.

In some instances, the device may transmit a ping message over the multi-drop serial bus, the ping message including status information for a plurality of active sources of the first coexistence information. The device may transmit a message over the multi-drop serial bus indicating that one or more sources of the first coexistence information is entering an inactive state.

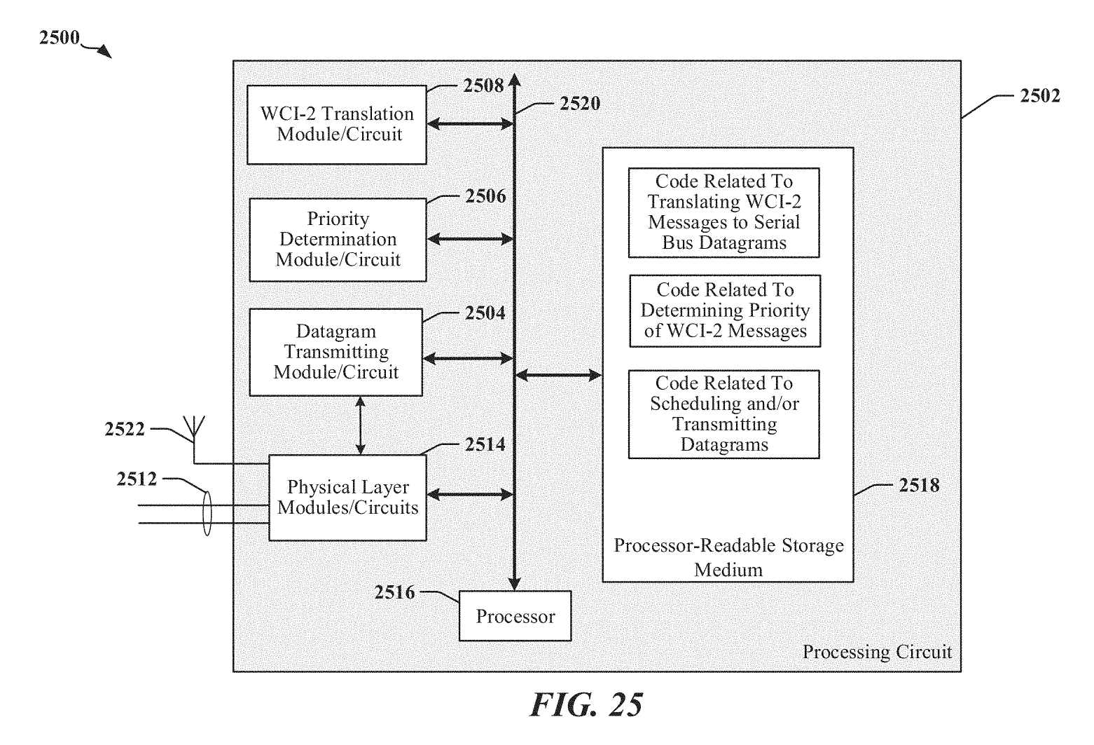

FIG. 25 is a diagram illustrating a simplified example of a hardware implementation for an apparatus 2500 employing a processing circuit 2502. The apparatus may implement a bridging circuit in accordance with certain aspects disclosed herein. The processing circuit typically has a controller or processor 2516 that may include one or more microprocessors, microcontrollers, digital signal processors, sequencers and/or state machines. The processing circuit 2502 may be implemented with a bus architecture, represented generally by the bus 2520. The bus 2520 may include any number of interconnecting buses and bridges depending on the specific application of the processing circuit 2502 and the overall design constraints. The bus 2520 links together various circuits including one or more processors and/or hardware modules, represented by the controller or processor 2516, the modules or circuits 2504, 2506 and 2508, and the processor-readable storage medium 2518. One or more physical layer circuits and/or modules 2514 may be provided to support communications over a communication link implemented using a multi-wire bus 2512, through an antenna 2522 (to a radio access network for example), and so on. The bus 2520 may also link various other circuits such as timing sources, peripherals, voltage regulators, and power management circuits, which are well known in the art, and therefore, will not be described any further.

The processor 2516 is responsible for general processing, including the execution of software, code and/or instructions stored on the processor-readable storage medium 2518. The processor-readable storage medium may include a non-transitory storage medium. The software, when executed by the processor 2516, causes the processing circuit 2502 to perform the various functions described supra for any particular apparatus. The processor-readable storage medium may be used for storing data that is manipulated by the processor 2516 when executing software. The processing circuit 2502 further includes at least one of the modules 2504, 2506 and 2508. The modules 2504, 2506 and 2508 may be software modules running in the processor 2516, resident/stored in the processor-readable storage medium 2518, one or more hardware modules coupled to the processor 2516, or some combination thereof. The modules 2504, 2506 and 2508 may include microcontroller instructions, state machine configuration parameters, or some combination thereof.

In one configuration, the apparatus 2500 is adapted for data communication and includes modules and/or circuits 2508 configured to translate WCI-2 messages to datagrams that may be transmitted over a serial bus, modules and/or circuits 2506 configured to determine a priority of the messages and/or characteristics of the serial bus or protocol controlling transmissions on the serial bus, and modules and/or circuits 2504 configured to transmit datagrams that include coexistence messages over the serial bus.

In one example, the processor 2516 may respond to messages being sent. The processor 2516 may organize how the bus interface should sort or order transactions when multiple transactions collide. Transactions may collide when they arrive at or close to the same time. In some instances, the processor 2516 can be involved in responding to messages received over a bus interface. In some instances, messages need immediate reaction and the bus interface may communicate directly with the RF transceivers (see RF transceivers 2312a and 2312b, for example).

In another example, the processor-readable storage medium 2518 may store, receive, maintain or otherwise have instructions stored thereon, which may be executable by a processor 2516 or state machine of a processing circuit 2502. The instructions may cause the processing circuit to receive first coexistence information directed to a first device coupled to a serial bus, select a first communication link to carry the coexistence information to a second chipset, generate the first datagram to include the first coexistence information, transmit the first datagram to the first device over the first communication link in a first mode of operation. The first datagram may be configured according to a protocol associated with the first communication link. The first datagram may be transmitted over a point-to-point link to the second chipset. In a second mode of operation, the first datagram is transmitted over a multi-drop serial bus to the second chipset. In some instances, the first datagram may be communicated through a UART in the first mode of operation.

In certain implementations, the instructions further cause the processing circuit 2502 to receive second coexistence information directed to a third chipset coupled to the multi-drop serial bus, and generate a second coexistence message representative of the second coexistence information. The second coexistence message may be transmitted in accordance with the second mode of operation. The second coexistence information may be configured for communication through a point-to-point data link.

In certain implementations, the instructions further cause the processing circuit 2502 to receive third coexistence information directed to a first radio frequency component coupled to the multi-drop serial bus, and generate a third coexistence message representative of the third coexistence information. The third coexistence message may be transmitted in accordance with the second mode of operation.

In certain implementations, the instructions further cause the processing circuit 2502 to generate fourth coexistence information from state of a physical GPIO pin, and generate a fourth coexistence message representative of the fourth coexistence information. The fourth coexistence message may be transmitted in accordance with the second mode of operation. The fourth coexistence message may include virtualized GPIO.

In certain implementations, the instructions further cause the processing circuit 2502 to determine an order of transmission for the two or more coexistence messages using a sorting table when two or more coexistence messages are received concurrently.

In certain implementations, the instructions further cause the processing circuit 2502 to select the multi-drop serial bus from the plurality of buses to be the selected bus that carries the coexistence information based on one or more characteristics of a protocol associated with the multi-drop serial bus when the multi-drop serial bus is one of a plurality of buses coupled to the first chipset. The one or more characteristics of the protocol may include bus latency and/or bus capacity.

In certain implementations, the instructions further cause the processing circuit 2502 to transmit a ping message over the multi-drop serial bus. The ping message may include status information for a plurality of active sources of coexistence information in the first chipset.

In certain implementations, the instructions further cause the processing circuit 2502 to transmit a message over the multi-drop serial bus indicating that one or more sources of coexistence information is entering an inactive state.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method performed at a first device, comprising:
receiving first coexistence information directed to a second device;
selecting a communication link to carry the first coexistence information to the second device;
generating a first datagram that comprises the first coexistence information, wherein the first datagram is configured according to a protocol associated with the communication link selected to carry the first coexistence information;
transmitting the first datagram to the second device over a point-to-point link in a first mode of operation; and
transmitting the first datagram to the second device over a multi-drop serial bus in a second mode of operation.

2. The method of claim 1, wherein the first datagram is communicated through a universal asynchronous receiver/transmitter (UART) in the first mode of operation.

3. The method of claim 1, further comprising:
receiving second coexistence information directed to a third device coupled to the first device;
generating a second coexistence message representative of the second coexistence information; and
transmitting a second datagram to the third device over a communication link selected to carry the second coexistence information.

4. The method of claim 3, wherein the second coexistence information is configured for communication through a point-to-point data link.

5. The method of claim 1, further comprising:
receiving third coexistence information directed to a first radio frequency component coupled to the multi-drop serial bus; and
generating a third coexistence message representative of the third coexistence information, wherein the third coexistence message is transmitted in accordance with the second mode of operation.

6. The method of claim 1, further comprising:
generating fourth coexistence information representative of signaling state of a physical general-purpose input/output (GPIO) pin; and
generating a fourth coexistence message comprising the fourth coexistence information, wherein the fourth coexistence message is transmitted in accordance with the second mode of operation.

7. The method of claim 6, wherein the fourth coexistence message comprises virtualized GPIO.

8. The method of claim 1, wherein coexistence information is received concurrently from two or more sources, further comprising:
using a sorting table to determine an order of transmission for coexistence messages comprising the coexistence information received concurrently from the two or more sources.

9. The method of claim 1, wherein the multi-drop serial bus is one of a plurality of serial buses coupled to the first device, further comprising:
selecting the multi-drop serial bus from among the plurality of serial buses to carry the first coexistence information based on one or more characteristics of a protocol associated with the multi-drop serial bus.

10. The method of claim 9, wherein the one or more characteristics of the protocol include bus latency.

11. The method of claim 9, wherein the one or more characteristics of the protocol include bus capacity.

12. The method of claim 1, further comprising:
transmitting a ping message over the multi-drop serial bus, the ping message including status information for a plurality of active sources of the first coexistence information.

13. The method of claim 1, further comprising:
transmitting a message over the multi-drop serial bus indicating that one or more sources of the first coexistence information is entering an inactive state.

14. An apparatus adapted for data communication, comprising:
a first communication interface configured to couple the apparatus to a multi-drop serial bus operated in accordance with a first protocol;
a second communication interface configured to couple the apparatus to a point-to-point link operated in accordance with a second protocol;
one or more coexistence message handlers configured to:
receive coexistence information directed to a first device coupled to the multi-drop serial bus and the point-to-point link; and
generate one or more coexistence messages representative of the coexistence information; and
a translator configured to:
provide the one or more coexistence messages in first datagrams configured to be transmitted to the first device over the multi-drop serial bus; and
provide the one or more coexistence messages in second datagrams configured to be transmitted to the first device over the point-to-point link.

15. The apparatus of claim 14, wherein the translator comprises a programmable core configured to:
select a communication interface to transmit the one or more coexistence messages based on one or more characteristics of the multi-drop serial bus and the point-to-point link.

16. The apparatus of claim 15, wherein the one or more characteristics include bus latency and bus capacity.

17. A processor-readable storage medium having instructions stored thereon which, when executed by at least one processor or state machine of a processing circuit, cause the processing circuit to:
receive first coexistence information directed to a first device coupled to the processing circuit;
select a communication link to carry the first coexistence information to the first device;
generate a first datagram that comprises the first coexistence information, wherein the first datagram is configured according to a protocol associated with the communication link selected to carry the first coexistence information;
transmit the first datagram to the first device over a point-to-point link in a first mode of operation; and
transmit the first datagram to the first device over a multi-drop serial bus in a second mode of operation.

18. The storage medium of claim 17, wherein the first datagram is communicated through a universal asynchronous receiver/transmitter (UART) in the first mode of operation.

19. The storage medium of claim 17, wherein the instructions further cause the processing circuit to:
receive second coexistence information directed to a third device coupled to the first device;
generate a second coexistence message representative of the second coexistence information; and
transmit a second datagram to the third device over a communication link selected to carry the second coexistence information.

20. The storage medium of claim 19, wherein the second coexistence information is configured for communication through a point-to-point data link.

21. The storage medium of claim 17, wherein the instructions further cause the processing circuit to:
receive third coexistence information directed to a first radio frequency component coupled to the multi-drop serial bus; and
generate a third coexistence message representative of the third coexistence information, wherein the third coexistence message is transmitted in accordance with the second mode of operation.

22. The storage medium of claim 17, wherein the instructions further cause the processing circuit to:
generate fourth coexistence information representative of signaling state of a physical general-purpose input/output (GPIO) pin; and
generate a fourth coexistence message comprising the fourth coexistence information, wherein the fourth coexistence message is transmitted in accordance with the second mode of operation.

23. The storage medium of claim 22, wherein the fourth coexistence message comprises virtualized GPIO.

24. The storage medium of claim 17, wherein coexistence information is received concurrently from two or more sources, and wherein the instructions further cause the processing circuit to:
use a sorting table to determine an order of transmission for coexistence messages comprising the coexistence information received concurrently from the two or more sources.

25. The storage medium of claim 17, wherein the multi-drop serial bus is one of a plurality of serial buses coupled to the processing circuit, and wherein the instructions further cause the processing circuit to:
select the multi-drop serial bus from the plurality of serial buses to carry the first coexistence information based on one or more characteristics of a protocol associated with the multi-drop serial bus.

26. The storage medium of claim 25, wherein the one or more characteristics of the protocol include bus latency.

27. The storage medium of claim 25, wherein the one or more characteristics of the protocol include bus capacity.

28. The storage medium of claim 17, wherein the instructions further cause the processing circuit to:
transmit a ping message over the multi-drop serial bus, the ping message including status information for a plurality of active sources of the first coexistence information.

29. The storage medium of claim 17, wherein the instructions further cause the processing circuit to:
transmit a message over the multi-drop serial bus indicating that one or more sources of the first coexistence information is entering an inactive state.

30. A data communication apparatus, comprising:
means for receiving coexistence information directed to a first device coupled to the apparatus through a plurality of communication links;
means for selecting a communication link from the plurality of communication links to carry the coexistence information to the first device;
means for generating a first datagram comprising the first coexistence information, wherein the first datagram is configured according to a protocol associated with the selected communication link; and
means for transmitting the first datagram to the first device over the selected communication link, wherein in a first mode of operation, the first datagram is transmitted over a point-to-point link to the first device, and wherein in a second mode of operation, the first datagram is transmitted over a multi-drop serial bus to the first device.
